(19) United States
(12) Patent Application Publication
(10) Pub. No.: US 2025/0381480 A1
(43) Pub. Date: Dec. 18, 2025

(54) SYSTEMS AND METHODS FOR PROVIDING PERSONALIZED DYNAMIC GAMING EXPERIENCES BASED ON MEDIA CONSUMPTION

(71) Applicant: Adeia Guides Inc., San Jose, CA (US)

(72) Inventors: Charles Dasher, Lawrenceville, GA (US); Reda Harb, Tampa, FL (US); Tao Chen, Palo Alto, CA (US); Christopher Phillips, Hartwell, GA (US)

(21) Appl. No.: 18/747,232

(22) Filed: Jun. 18, 2024

(51) Int. Cl. A63F 13/525

(52) U.S. Cl. CPC A63F 13/525

(57) ABSTRACT

Methods, systems, and devices are described herein for tracking a user's consumption data on a media streaming platform; determining unique elements of the user consumption data by a game customization engine; rendering unique elements of the user consumption data; populating the renderings of the unique elements for use by a game application; and updating a gameplay session on a game application with the rendered unique elements.

### BACKGROUND

The present disclosure relates to methods and systems for providing a combined system for providing integration for media streaming and gaming platforms. In particular, techniques are provided for a streaming platform tracking consumption progress and communicating data used to adjust gaming sessions.

### SUMMARY

In recent years, there has been a growing demand for content delivery systems to provide more interactive and personalized entertainment experiences tailored to preferences and interests of a user profile maintained by the system. For example, a system may customize experiences based on a user profile that tracks viewing and gaming consumption data.

In light of this trend, the provision of gaming technologies continues to capitalize on immersive capabilities, such as through virtual reality (VR), role-playing games (RPGs), first-person shooters (FPS), other types of adventure games, or a combination thereof. Immersive simulation games, also known as “immersive sims,” tend to be commercially successful because they prioritize a player's agency in complex and deep game worlds, allowing players to become captivated with a player-driven game narrative. Immersive sims provide players with options to choose pathways to solve game challenges, customize game characters and game worlds, and engage with other players through unique game states. Advancements in digital technology, in areas such as AI, physics simulation, and graphical fidelity, have expanded the possibilities for immersive sim experiences, enabling developers to create even more complex and dynamic game worlds.

Often, game developers produce game worlds based on trending and popular media content, such as movies, TV shows, and books. For example, the fantasy action role-playing game “The Witcher” is based on a book series of the same name, which was also made into a TV show, a comic book series, and a movie. However, with the growing popularity of such video games and the continuing development of relative media content, games of the same series demand new game versions and spin-off games to keep up with their expanding fictional world. Furthermore, such games are typically static, predetermined by the game's developers, and not influenced by the player's personal interests or media consumption habits outside of the gaming environment. This results in a stagnant disconnection between the immersive worlds of gaming and the equally engaging world of media consumption.

In one approach, game developers build highly complex game worlds and narratives to provide players with evolving challenges through dynamic gameplay using various techniques such as procedural generation, AI, and physics simulations. The additional layers of challenge to the gameplay lessen the possibility of the game becoming repetitive and predictable for players. Complex gameplay allows players to feel a sense of agency in the game, wherein different decisions and pathways produce different solutions and outcomes. However, this presumed agency is still written into the game narratives by the game developers. While the system provides player-controlled characters with the freedom to make choices within the game world, these choices may ultimately have limited consequences or affect only localized aspects of the game story. These dynamic games do not adapt storylines or game elements that were not originally initiated by the game developers.

In another approach, the system may provide a user interface for users to manually customize characters and game worlds during gameplay (e.g., game “modding”) such as customizing the character's appearance by changing or purchasing skins, swapping gameplay elements by changing or purchasing tools or weapons, and changing the scenery or setting of the game world (with or without the support from the game platform).

In one approach to make gameplay a more personalized experience, the gaming platform may provide recommendations for video games to a user device based on profile data that track consumption of previously watched media content on media streaming platforms by devices logged in to an account associated with the same user. This approach allows for a gaming platform to recommend games that match to a user profile where the profile is based on learned preferences for certain media content. However, this approach does not provide for unique and dynamic gameplay sessions personalized per user profile as the game remains static and constant no matter the profile logged in to the system. The game remains static as it comprises the same storyline, plots, and objects for varying profiles. This systematic approach lacks dynamic storytelling and results in mundane, repetitive, or predictable gameplay sessions that do not reflect the uniqueness and individuality of the user profiles it services. Furthermore, video games are recommended via high-level metadata descriptors (e.g., brand, actor/actress name, producer, and genre), not specific metadata like plot progression descriptors or other specific metadata descriptors that differentiate one episode in a series from another.

To help address these problems, systems, methods, and apparatuses are disclosed herein to allow for an intermediate server (e.g., game customization engine and/or media integration engine) to populate elements from media consumed by a user profile into a game. And in the bi-directional case, elements that a user profile interacts with, builds, or discovers from a game can be integrated with correlating media. The disclosed system further provide a collection of digital resources associated with the consumed media, such as character outfits, scenery, objects, tools, weapons, and other types of digital resources that appeared in the consumed media, to the game customization engine. The disclosed system further modifies a gameplay session of a user profile using the game customization engine to include at least one of the digital resources associated with the consumed media.

In a non-limiting example, the system detects that a user profile streaming media comprising a plurality of metadata reaches a threshold of time, and therefore the streamed media is identified as “consumed” by the system. The media now tagged as consumed allows for the metadata of the tagged media to be uploaded to a separate server for analysis and/or processing. While on a separate server, the metadata in some embodiments are parsed and analyzed to identify key elements from the media such as characters, settings, objects, and plot points, etc. A preconfigured template for such analysis can be loaded on the analysis server. Other methods for system analysis and identification of key elements include using artificial intelligence, machine learning, object recognition models, image processing models, augmented reality algorithms, or identification of elements pre-determined by the media creators, among others. In the disclosed system, the identified key elements from the media are integrated into the game by the intermediate server.

For example, the media streaming platform server identifies a user profile that has data indicating consumption of the third episode of a TV show. The metadata for the third episode may comprise data indicating a new outfit worn by one of the characters in the show. In some embodiments, metadata includes textual information (e.g., code, script, written descriptors) from the TV show. In other embodiments, metadata refers to textual information resulting from analysis done by an image processor extracting information from a frame(s) of the TV show. In a non-limiting example, the image processor receives an image (e.g., frame(s) from the video, screen shot), and the image comprises a character in a unicorn costume. The image is processed so that the image processor metadata from the image analysis outputs may include unicorn, costume, pink, single horn, and magical creature. The metadata output from the image processor is uploaded to the game customization engine wherein a skin is generated based on the output metadata. The user profile opens a gameplay session on a game application correlating to the TV show and is given an option to upload a unicorn outfit generated by the game customization engine using metadata introduced in the third episode. In some embodiments, the skin in the gameplay session is rendered by the game customization engine; in other embodiments, the game customization generates code for the game application to render.

In some embodiments, new elements discovered in a gameplay session are identified by a media integration engine to be incorporated back into correlating media of the game. In some embodiments, the media integration engine may identify new elements by parsing logs from the gameplay session. In some embodiments, activities logged during a gameplay session have metadata correlated to the logged activity. For example, a playable character in the gameplay session unlocks (e.g., action) correlated metadata (e.g., black leather armor). The logged action automatically highlights the correlated descriptors as a new game element. Black leather armor is then processed by the media integration engine to render black leather armor over a character in the show. In some embodiments, actions in the gameplay session trigger the media integration engine to render an element in the correlating show. In some embodiments, an intermediate server identifies areas within scenes (e.g., frames) from the media that are compatible for integration of game-derived elements by using advanced algorithms to identify static areas within the scenes of the content, which are suitable for placing objects or animations from the game. In some embodiments, the game comprises pre-programmed “zones” that correlate to “zones” in the frames of a video to render objects in the zones of a game to zones in the streamed media.

In one embodiment, the intermediate server may identify a connection between a user profile for a gaming account with a user profile on a media streaming service account. For example, a gaming account on a gaming platform and a subsequent media streaming service account on a media streaming platform are linked together by a third user account on an intermediate server (e.g., media integration engine, game customization engine). In another embodiment, the platform providing both gaming and media services is accessed by the same user profile.

In another embodiment, the system may monitor the user profile's media viewing history in order to generate game content that is (e.g., plots, characters, cut-scenes, objects, levels, etc.) based in-part on the profile's viewing history (e.g., episodes watched, TV series watched, movies watched, progress of shows, progress of movies, etc.). In some embodiments, the system may perform a media analysis on media content related to the player's media viewing history. The system may perform the media analysis using models such as natural language processing (NLP), machine learning (ML), computer vision (CV), generative AI (GenAI), large language models (LLMs), and other computation models for the use of classification of media content, among others. The system may output from the media analysis identifications of diverse features within the media content, including key elements for use in the game generation.

In another embodiment, the game customization engine dynamically generates and updates game content to include key elements that were identified through media analysis. For example, when a user profile engages in gameplay of a game related to media content, the system may identify that the user profile is also consuming media content. The intermediate server, in some cases, may update the gameplay session with new key elements as the media content is being consumed, simultaneously. In some embodiments, the intermediate server recognizes a change in the viewing preference of the media consumption and updates the gameplay session with key elements based on the change in viewing preference.

In another embodiment, the system may access a database from the media content platform related to key elements in the media content. For example, the creators of a TV show on the media content platform may develop application programming interfaces (APIs) related to key elements, such as character models, for use by third-party developers. The system may directly use the APIs provided by the media content platform to create game versions of the key elements for integration in the game world. In some embodiments, the system may retrieve the viewing history of the user profile from the media content platform and match elements from the database to the viewing history. The system may only introduce key elements for integration in the game world if the element from the database was also in the user profile's media viewing history. As used herein, the terms “player(s)” and “player profile(s)” includes any user profile(s) within game or media systems.

Methods, systems, and devices are described herein to provide for an integration system by using an intermediate server (e.g., game customization engine, media integration engine) to connect a game and with correlated media. The intermediate server allows for a bi-directional pathway for elements identified in media provided by a media streaming platform to populate as elements in a game. Additionally, the integration system allows for elements in a game provided by a game streaming platform to render elements to media.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows a system diagram for customizing game content based on elements in media content, in accordance with some embodiments of this disclosure.

FIG. 2 shows a system diagram for incorporating game elements into media content, in accordance with some embodiments of this disclosure.

FIG. 3 shows a system diagram for customizing a multi-player game session based on elements in media content from a multi-user watch party, in accordance with some embodiments of this disclosure.

FIG. 4 shows a system diagram of integrating game elements from a multi-player game session into media content of a multi-user watch party, in accordance with some embodiments of this disclosure.

FIG. 5 shows a system diagram for customizing a multi-player game session based on received commentary from users in a multi-user watch party, in accordance with some embodiments of this disclosure.

FIG. 6 shows a system diagram for identifying media elements from an interactive media content item and customizing game content based on the identified media elements, in accordance with some embodiments of this disclosure.

FIG. 7 shows an illustrative flowchart describing a media analysis module monitoring a user's media viewing history in order to generate game content, in accordance with some embodiments of this disclosure.

FIG. 8 shows an illustrative flowchart describing a media integration module incorporating elements from a game experience into media content streamed by a user, in accordance with some embodiments of this disclosure.

FIG. 9 shows an illustrative flowchart describing a user preference and feedback system to specify types of media elements to implement in game content, in accordance with some embodiments of this disclosure.

FIG. 10 shows an illustrative flowchart describing a multi-use integration system for shared gaming or content viewing experiences, in accordance with some embodiments of this disclosure.

FIG. 11 shows an illustrative flowchart describing generated game content presented to a user wearing an XR headset, in accordance with some embodiments of this disclosure.

FIG. 12 shows an illustrative flowchart of a system to generate personalized video games based on a user's progress in viewing media content, in accordance with some embodiments of this disclosure.

FIGS. 13-14 show illustrative devices and systems for generating gaming content or media content based on viewed media content or played game content, in accordance with some embodiments of this disclosure.

FIG. 15 shows a flowchart describing the customization of game content, in accordance with some embodiments of this disclosure.

FIG. 16 shows a flowchart describing the bi-directional integration of media content, in accordance with some embodiments of this disclosure.

### DETAILED DESCRIPTION OF THE DRAWINGS

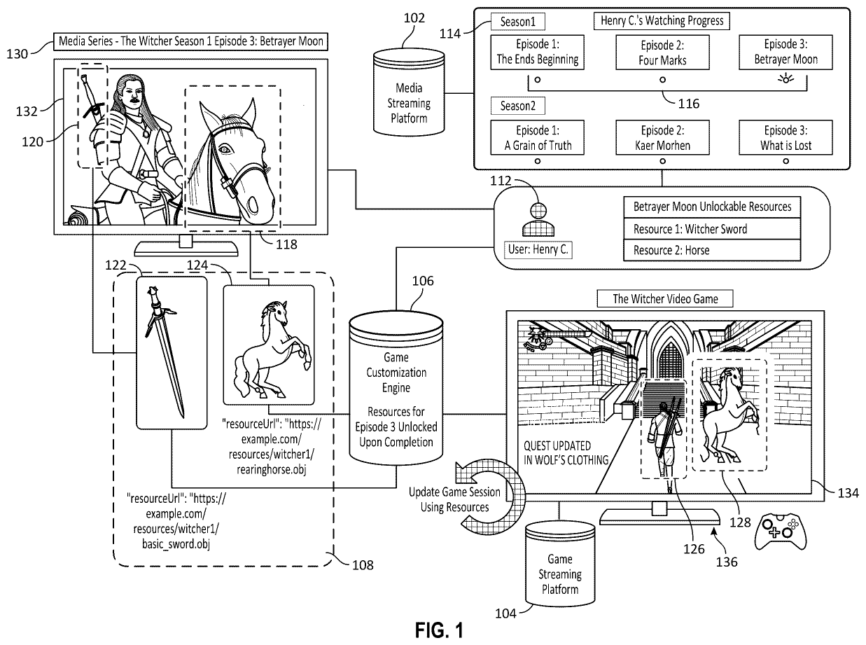

FIG. 1 shows an illustrative system for customizing game content based on consumption of media of a user profile, in accordance with some embodiments of the present disclosure. System 100 comprises media streaming platform 102 (corresponding to media streaming platforms 202, 302, 402, 502, and 602, media content service 702, streaming service 802, and interactive media content platform 1202); game streaming platform 104 (corresponding to game streaming platforms 204, 304, 404, 504, and 604, game streaming platform hosting game 704, content update service 804, and game streaming platform hosting game 1204); and game customization engine 106 (corresponding to game customization engines 306 and 506). Game customization engine 106 is communicatively coupled to media streaming platform 102 and game streaming platform 104 by way of a communication network and communication paths. The communication network may be any type of communication network, such as the internet, a mobile phone network, mobile data network (e.g., a 4G or LTE network), cable network, public switched telephone network, public cloud network, private cloud network, LAN network, WAN network, wireless network, any other communication network, or a combination thereof. The communication network includes one or more communication paths, such as a satellite path, a fiber-optic path, a cable path, a path that supports internet communications (e.g., IPTV), free-space connections (e.g., for broadcast or other wireless signals), any other suitable wired or wireless communication path, or a combination thereof.

Game customization system 100 links a profile for gaming 134 (e.g., Steam™, Xbox™, PlayStation™, Amazon Luna™, etc.) with a profile for media streaming 130 (e.g., Netflix™, Hulu™, Amazon Prime™, etc.) by way of an intermediary server 106 (e.g., game customization engine). In some embodiments, the intermediary server 106 receives data from the media streaming server 102 indicative of consumption progress 116 for the logged-in user profile. As a non-limiting example, FIG. 1 depicts user profile “Henry C” 112 logged in to a media streaming platform 102 and a game application 104, which are both receiving and sending data to game customization engine 106. Media streaming platform 102 sends metadata to the game customization engine comprising viewing data 114.

For example, media streaming platform 102 may have initiated a data structure (e.g., an array) for each user profile, wherein the data structure maps each of the plurality of content items (e.g., shows, movies, media data) available through media streaming platform 102. Media streaming platform 102 may determine that the user profile is consuming “Avengers: Infinity War.” Media streaming platform 102 searches the array for an index matching “Avengers: Infinity War” and inserts into the mapping data indicative of the user's watch time, watch progress, etc. In other examples, media streaming platform 102 maps viewing history of a user profile in other data structures such as a viewing queue, list, heap, stack, other data structures temporarily or permanently stored in memory, or a combination thereof.

In another example, media streaming platform 102 determines that a user profile consumed “Avengers: Infinity War” and logs the consumption data related to the user consumption progress of “Avengers” in a data structure (e.g., a stack). Media streaming platform 102 determines that the user profile also consumes “Point Break” and logs the consumption data related to the user consumption progress of “Point Break” in the stack. Game customization engine 106 sends a request to media streaming platform 102 for viewing history related to the user profile, and data related to the point breaks are sent to the game customization engine as consumption data.

In the example illustrated by FIG. 1, user profile Henry C is detected by the game customization engine 106 to have completed watching several episodes of The Witcher Season 1 including S1 episode 3: Betrayer Moon. Media streaming platform 102 first determines that a user profile consumed “The Witcher Season 1 Episode 3: Betrayer Moon” and logs the consumption data related to the user profile's consumption progress of “Betrayer Moon” in a data structure (e.g., a stack). Game customization engine 106 sends a request to media streaming platform 102 for viewing history related to the user profile, and the stack is sent by the media streaming platform to the game customization engine in an encrypted format. Once the game customization engine 106 receives the encrypted data, the customization engine 106 (i.e., intermediary server) decrypts the stack to determine that Henry C's profile has consumed “Betrayer Moon”.

In another embodiment, the game customization engine 106 sends a request to media streaming platform 102 through an API call configured to communicate between a computing server (e.g., game customization engine 106) and the media streaming platform 102 to retrieve Henry C's viewing history 114. For example, the request API may be as shown:

```
{
  “requestType”: “getUserViewingHistory”
  “apiKey”: “YourStreamingServiceAPIKey”
  “userID”: “Henry_C”
}
```

In some embodiments, the game customization engine 106 receives a response from the media streaming platform 102 including viewing data 114 of Henry C's profile from the API call. In some embodiments, the response may include a resource locator for game customization engine 106 to access interactive data (i.e., resources) for the media elements that can be integrated into the video game. The resource locator points to a location in memory on a server within the media streaming platform or outside the media streaming platform (e.g., on a cloud server). The interactive data for the media elements are stored in a resource database at the location in memory. The response from the media streaming platform 102 to the game customization engine 106 may include a list of indicators for categories of media elements that can be integrated into a video game 134. For example, the list of indicators may be categorized as the following: skins, maps, character models, objects, abilities, narrative elements, or other types of media elements. The response may also include the availability of each of the categories of media elements listed below:

```
{
  “skins”: true;
  “maps”: false;
  “characterModels”: true;
  “narrativeElements”: true;
}
```

In the example of FIG. 1, the media elements are identified by the game customization engine to comprise a sword and a horse, as consumed/observed in “Betrayer Moon.” The metadata of “Betrayer Moon” introduces the media element “horse” under the indicator category “object” as well as “sword” also under the indicator category object. In some embodiments, the resources (e.g., Witcher sword and the horse) are pre-set resources developed by the producers of the system to be unlocked when the user profile has consumed the associated media content of the resources. For example, the producers of the game customization engine, in one embodiment, may have generated a library containing a plurality of resources, which are digitized items seen in the consumed media. The game customization engine may be hosted on a cloud and/or server and that server may comprise a database of a plurality of resources saved to the server. The plurality of resources already contain code, related to the game's API, ready to be released into the game session once the system identifies the related media of the associated episode to be released.

In some embodiments, interactive data for the media elements 122 and 124 stored on the resource database (e.g., game customization engine 106) may be media object files 118 and 120 extracted from the media content by a media analysis application. For example, the media analysis application may run a frame of the video through an object recognition algorithm to determine items what may be used as media elements. In other embodiments, interactive data for the media elements 118 and 120 may be video game object files created by the media content producers for the purpose of video game integration, wherein the video game object files 122 and 124 can be directly inserted into the video game using developer tools on game streaming platform 104. In yet another embodiment, interactive data for the media elements 118 and 120 may be program instructions for creating video game object files 122 and 124. For example, the interactive data for the media elements may instruct the colors, size, texture, other visual details, or a combination thereof, to guide the rendering of similar video game object files using a rendering algorithm or image synthesis algorithm by game customization engine 106. The consumption progress 112 collected from the media streaming platform 102 is used by game customization engine 110 to unlock digital resources associated with sequential video content items 108. The game customization updates the game with the new resources 114 reflecting user's media consumption in the game session.

In some embodiments, the media analysis application (i.e., media analysis module) monitors, with permission from a user profile, media viewing history (i.e., consumption data) of a user profile to generate game content (plots, characters, cut-scenes, objects, levels, etc.) based in part on the user's profile consumption data (e.g., episodes, series, etc.). In some embodiments, the media analysis application is a computational server that comprises programs such as NLP, ML, computer vision, generative AI, LLMs, etc. In some embodiments, the media analysis application utilizes a combination of sophisticated machine learning algorithms and natural language processing techniques, which are trained on extensive media datasets to accurately recognize and categorize diverse features within the media content. By using sophisticated machine learning algorithms and/or natural language processing techniques, the media analysis application extracts identified elements from the uploaded media that reflect a user profile's preferences and viewing patterns. In some embodiments, the integration system receives input from the media analysis application to feed to the game customization engine. The game customization engine in some embodiments is equipped with development tools and libraries, enabling it to create unique game levels, characters, objects, and plots that are not only inspired by but also closely mirror a user profile's consumption of media content. A key feature of this engine is its dynamic updating capability.

In some embodiments, media streaming platform 102 may be provided through a user interface on a user device such as a television, tablet, mobile device, VR device, AR device, any other smart device, or a combination thereof. In some embodiments, media streaming platform 102 may be a content delivery platform configured to distribute media content over a content delivery network (CDN).

In one embodiment, game customization engine 106 is implemented on a computing server separate from a gaming server hosting the game streaming platform 104. For example, a video game may have been developed with developer tools for individuals to modify or add elements into the video game. The computing server may request to be or have been pre-coded with an API compatible to the developer tools for the video game. Game customization engine 106 on the computing server receives input such as media content, user viewing history, or media content elements from media streaming platform 106 or from a media analysis application. Game customization engine 106 on the computing server may output, using the API compatible to the developer tools for the video game, game elements for integration into the media game. In some embodiments, the computing server may have I/O circuitry configured to convert a media content element into a video game element with a file type that is compatible with the video game. For example, the input/output (I/O) circuitry may be configured to render 3D models from 2D inputs. In some embodiments, the computing server and the gaming server may be within the same communication network.

In another embodiment, game customization engine 106 is implemented on a gaming server hosting the game streaming platform.

In some embodiments, game customization engine 106 may comprise a rendering algorithm or image synthesis algorithm that is configured to seamlessly integrate game elements into the video game. In some embodiments, the system may use the rendering algorithm or image synthesis algorithm on game streaming platform 104 to integrate game elements received from game customization engine 106 into the video game.

In some embodiments, a media analysis application (corresponding to media analysis application 708) is used to analyze media content of the media streaming platform to generate resources for the game customization engine. The media analysis application may in part generate content including plots, characters, objects, levels, skins, etc. In one example, the media analysis application retrieves data indicating a new utterance mentioned by Geralt, a character in “The Witcher” wherein the new utterance comprises metadata of a monster class not already discovered in the game. The media analysis module then sends a side quest related to the monster to the game customization engine, and a new side quest is unlocked in the associated gameplay session. In some embodiments, the media analysis module uses NLP, ML, Computer Vision, Generative AI, LLMs, etc. In other embodiments, the media analysis module utilizes a combination of sophisticated machine learning algorithms and natural language processing techniques, which are trained on extensive media datasets to accurately recognize and categorize diverse features within the media content. In some embodiments, the media streaming platform's server calls API “getGameCustomizationOptions” to the game customization engine and calls API “updatesGameModel” with gameID to the game customization engine.

In some embodiments, the game customization 106 engine updates the video game on game streaming platform 104 based on viewing progress of the content from the viewing history. Media streaming platform 102 may directly send an API call to game streaming platform 104 to update the game. For example, the media streaming platform sends an API request to the game streaming platform as shown:

```
{
  “requestType”: “getGameCustomizationOptions”;
  “apiKey”: “YourContentProviderAPIKey”;
  “contentProviderID”: “UniqueContentProviderID”;
  “mediaContentID”: “UniqueMediaContentID”;
  “title”: “The Witcher”;
}
```

The media streaming platform 102 may receive a response from the game streaming platform 104 for with options to customize certain game elements. The response from the game streaming platform may be as shown:

```
  {
    “status”: “success”;
    “mediaContentID”: “UniqueMediaContentID”;
    “title”: “The Witcher”;
    “customizationOptions”: {
      “skins”: {
        {
          “name”: “The Witcher Armor Gear”;
          “description”: “Dress your character with gear suitable for
a battle”;
          “resourceURL”:
“https://game.example.com/resources/skins/battle-armor”;
        }
        {
          “name”: “Island Explorer Outfit”;
          “description”: “An outfit designed for those who wish to
explore every corner of Mystery Island”;
          “resourceURL”:
“https:/game.example.com/resources/skins/island-explorer-outfit”;
        }
      }
      “maps”: {
        {
          “name”: “Mystery Island Map”;
          “description”: “A detailed map of Mystery Island, revealing
hidden paths and secret locations”;
          “resourceURL”:
“https://game.example.com/resources/maps/mystery-island-map”;
        }
      }
      “characterModels”: {
        {
          “name”: “The Artifact Guardian”;
          “description”: “A model of the Artifact Guardian, the
mystical protector of the island's secrets”;
          “resourceURL”:
“https://game.example.com/resources/characters/artifact-guardian”;
        }
      }
      “narrativeElements”: {
        {
          “name”: “The Hidden Artifact Adventure”;
          “description”: “A series of quests inspired by the hunt for
the hidden artifact on Mystery Island, filled with puzzles and challenges”;
          “resourceURL”:
“https://game.example.com/resources/narratives/hidden-artifact-adventure”;
        }
      }
    }
    “message”: “Customization options for 'The Witcher' retrieved successfully”;
  }
```

In one embodiment, the media streaming platform 102 selects the option to update the character model for the game. The media streaming platform 102 may send the selection through an API call to the game streaming platform 104, and may be as shown:

```
  {
    “requestType”: “updateGameModel”;
    “apiKey”: “YourContentProviderAPIKey”;
    “contentProviderID”: “UniqueContentProviderID”;
    “mediaContentID”: “UniqueMediaContentID789”;
    “title”: “The Witcher”;
    “updateDetails”: {
      “modelType”: “characterModels”;
      “modelName”: “rearingHorse”;
      “newResourceURL”: “https://example.com/resources/characters/new-
rearing-horse”;
      “updateNotes”: “Enhanced model with improved textures and animations
for a more lifelike appearance.”
  }
```

In some embodiments, the media streaming platform 102 may send the selection through an API call including a game identifier to the game streaming platform 104, as shown:
“gameID”: “UniqueGameID”;

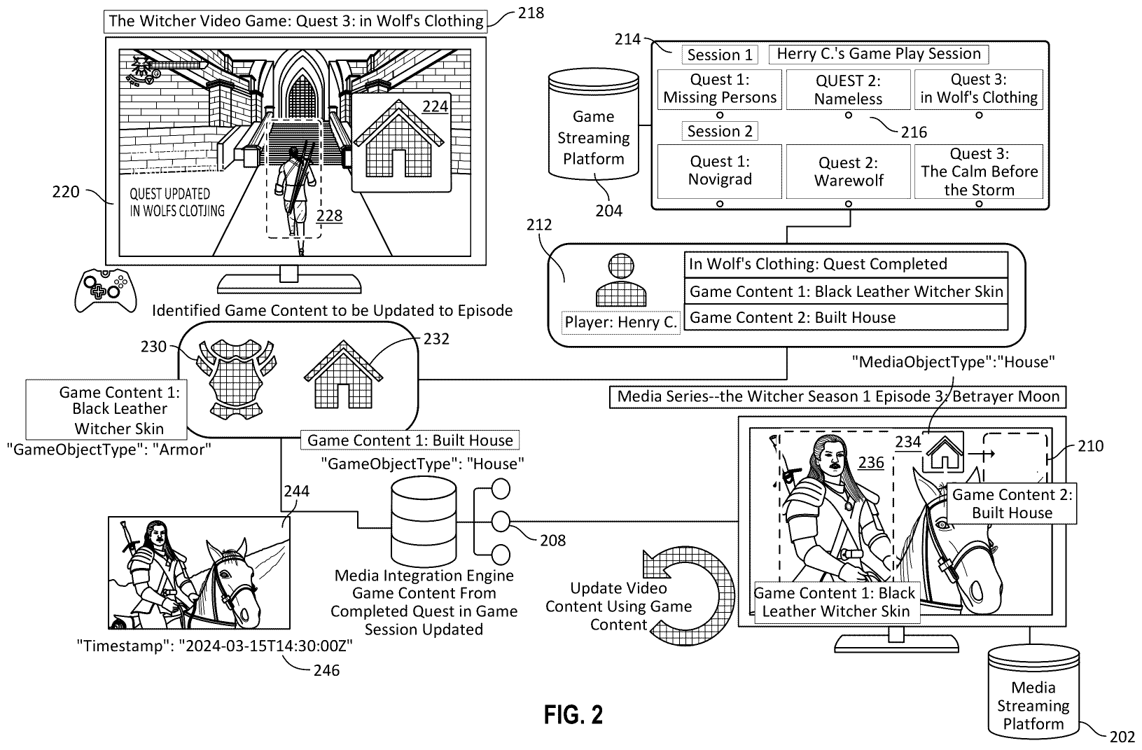

FIG. 2 shows an illustrative diagram of an integration application system 200 for providing a personalized media experience, in accordance with some embodiments of this disclosure. In addition to generating game content from media as shown by the example in FIG. 1, the system and methods also functions in a bi-directional manner, meaning that elements from the game are incorporated back into the subsequent episodes of the series or shows watched by the user profile. For example, user profile Henry C 212 logging in to the integration application 200 in one embodiment on an intermediate server (i.e., media integration engine 208) causes the media streaming platform 202 and the game streaming platform 204 to be communicatively linked to one another. Henry C may change an outfit that his game character is wearing, and the same outfit gets worn by the matching character in the TV show.

In the particular example shown in FIG. 2, system 200 comprises media streaming platform 202 (corresponding to media streaming platforms 102, 302, 402, 502, and 602, media content service 702, streaming service 802, and interactive media content platform 1202), game streaming platform 204 (corresponding to game streaming platforms 104, 304, 404, 504, and 604, game streaming platform hosting game 704, content updating service 804, and game streaming platform hosting game 1204), and media integration engine 208 (corresponding to media integration engines 408, 808, and 1008). Game streaming platform 204 may be running a game session 218 on gaming device 220 under player profile 212. In some embodiments, gaming device 220 is automatically associated with player profile 212.

Media streaming platform 202 may be streaming a media content item that is related to the game content on game streaming platform 204. For example, the media streaming platform may determine from a user profile for player Henry C that the player may be watching “The Witcher: Season 1” which is related to a game he is currently playing, “The Witcher Video Game.” In some embodiments, the system may determine that a media content item related to the game content is being consumed based on player profile 212 having a linked user profile on media streaming platform 202. In other embodiments, the media integration engine 208 or any other server may determine that a media content item related to the game content is being consumed by retrieving user viewing data from media content platform 202 for a user profile that is owned by the same user as the one owning player profile 212. The system may determine that the user profile is owned by the same user as the one owning player profile 212 by matching both the user profile and player profile's email, phone number, username, or other user identifier, such as an identifier ID, identity signature, other identifiers, or a combination thereof.

Media integration engine 208 receives data for game elements 230 and 232. In some embodiments, the data for the game elements comprise instructions regarding the digital object class of the game element, as shown:

“gameObjectType”: “Armor”
“gameObjectType”: “House”

The instructions may include attributes for the object class such as texture, color, size, inheritable features, or other features in the object class parallel to the physical attributes of the game elements. For example, the media integration engine 208 may receive from the game streaming platform 204 data for armor that the player profile selected for the game character. The media integration engine may receive attribute data regarding the armor, such as data indicating that the armor is black, is made of leather, is fitted on the upper body, etc. Media integration engine 208 may generate a media version of game elements 230 and 232 using the attribute data as input. The media version of game elements 230 and 232 is of the same type as the media and may be generated by a preprogrammed algorithm, generative AI, 3D model generator, video generator, or other type of image or media generator. For example, the media integration engine may generate 2D images of the game elements for insertion into video frames, 3D models of the game elements for insertion into 3D media content, 3D-VR models of the game elements for insertion into VR content, or other models of a type that matches the media type. In other embodiments, media integration engine 208 receives the media version for game elements 230 and 232 directly from game streaming platform 204.

In some embodiments, media integration engine 208 also receives game progress data 214 from game streaming platform 204. Game progress data 214 indicates how much of a game that user profile 212 has progressed. In some embodiments, the game progress data comprise completion of certain quests 216 of the video game. In the example shown in FIG. 2, the game progress data indicates that player Henry C has played quests 1-3 for the video game “The Witcher.” Game progress data 214 also comprise of data for game elements 230 and 232, which is extracted when received by media integration engine 208.

In some embodiments, media integration engine 208 takes in input of game-related media content from media streaming platform 202. In some embodiments, media integration engine 208 sends a request to media streaming platform 202 to receive frames or sections of the media content that are related to the portions of the video game that game progress data 214 has indicated as played. Media integration engine 208 may receive from media streaming platform 202 the frames or sections of the media content that are related to the portions of the video game. In the example shown in FIG. 2, media integration engine 208 may receive an image frame of a scene from “The Witcher: Season 1 Episode 3—Betrayer Moon” along with metadata related to the scene. The metadata related to the scene may include data indicating the timestamp of the image frame 246, media element 236 from the scene, and other types of metadata that may describe the media content in further detail.

In one embodiment, media streaming platform 202 may receive an API call from game streaming platform 204 to update the related media content based on game selections or game actions by a player profile's character within the game. In another embodiment, game streaming platform 204 sends to media integration engine 208 within media streaming platform 202 the API call to update content. In yet another embodiment, game streaming platform 204 sends to media integration engine 208 the API call to update content, wherein media integration engine 208 functions on a separate server than media streaming platform 202. For example, the request API from game streaming platform 204 to media integration engine 208 or media streaming platform 202 may be as shown:

```
  {
    “requestType”: “updateMediaContentBasedOnGameplay”;
    “apiKey”: “GameEngineAPIKey”;
    “gameID”: “UniqueGameID456”;
    “userID”: “UniqueUserID789”;
    “mediaContentID”: “UniqueMediaContentID789”;
    “title”: “The Witcher: Season 1 Episode 3 - Betrayer Moon”
    “gameplayEvents”: {
      “eventID”: “HouseDestruction”;
      “eventType”: “ObjectDestruction”;
      “description”: “User destroyed house in the game”;
      “timestamp”: “2024-03-15T14:30:00Z”;
      “impactOnMediaContent”: “Reflect destruction of the corresponding
house in the media content”;
    }
  }
```

In some embodiments, system 200 includes a user preference and feedback interface to receive input from users specifying the types of media elements to be reflected in the game. For example, the user preference feedback interface may receive input selecting a user's favorite genres, characters, episodes, series, movies, or other media elements to be incorporated into the gaming experience. For example, the system may determine that a user has watched new media content from the viewing data. The system may present through the user device an option to generate a new game based on the series. In some embodiments, the system may send a notification to the user device to indicate that the game has been updated. In other embodiments, the system may send a notification to the user device to indicate that a new version of the media content has been created or updated. In some embodiments, the user preference and feedback interface may receive selections from a user device of certain characters or other elements to include in the game by the game customization engine.

In some embodiments, game streaming platform 204 receives input with data indicating an interactive element within the game has been modified and sends a request to the game customization engine to update the game content based on the gameplay event. For example, the game streaming platform detects that a user profile has destroyed a house object in the game world. The request includes instructions regarding the interactive element and the action done upon the interactive element. For example, the game streaming platform sends an API request to the game streaming platform as shown:

```
“gameplayEvents”: {
  “eventID”: “HouseDestruction”;
  “eventType”: “ObjectDestruction”;
  “objectType”: “House”;
  “description”: “User burned a house in the game”
}
```

The game customization engine then updates the video game on game streaming platform 204 to include the modification to the interactive element 224, a house and/or a zone in which to construct a house. For example, the game customization engine replaces the original house object in the game world with a copy of the house object, wherein the copy is engulfed in flames. The game customization engine then receives a synchronization request from the video game platform to update the video game to have the house engulfed in flames.

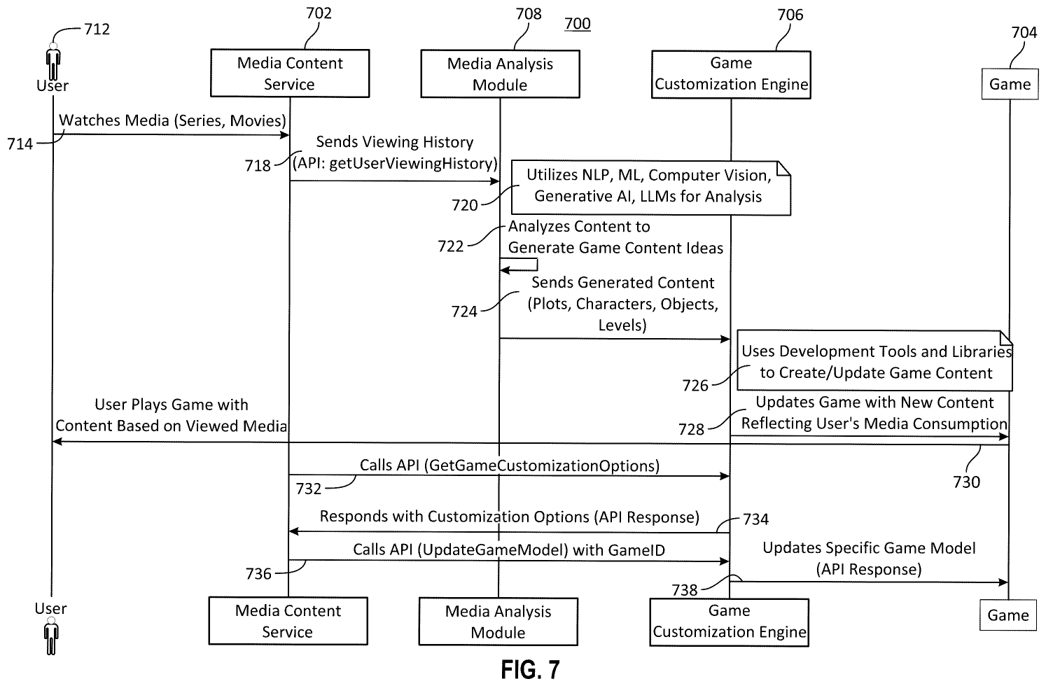

In some embodiments, media integration engine 208 passes the received media content 244 from media streaming platform 202 to an image recognition server. The image recognition server (corresponding to 810 from FIG. 8) may be within media integration engine 208 or may function on a separate server. In some embodiments, the image recognition service may apply an image recognition algorithm or an augmented reality algorithm on the received media content 244 to analyze the scenes within the received media content and output data indicating areas within the scenes that are suitable for integration of game-derived elements. For example, the image recognition engine may output data describing a boundary within frames in the media content wherein there exists static backgrounds or less dynamic portions of the scene to insert game-derived elements. In the example shown in FIG. 2, the image recognition engine outputs the boundary 210 for insertion of game element 234 because the pixels within boundary 210 are determined to be less dynamic than other portions of the scene. In some embodiments, media integration engine 208 overlays the media version of the game element onto the area within boundary 210 into the media content.

In some embodiments, the image recognition engine may apply an object recognition algorithm or any other deep learning or machine learning algorithm on the received media content 244 to analyze the scenes within the received media content and output data indicating recognized objects, such as characters, items, and other recurring media objects. For example, the image recognition engine may recognize the character Geralt 236 in the media content. In some embodiments, media integration engine 208 receives game-derived element 230 and generate a media version of the game element as in methods described previously. Media integration engine 208 may overlay the media version of the game element onto the character, Geralt 236, in the media content. In some embodiments, media integration engine 208 may use an AI algorithm to seamlessly blend the media version of the game element onto the identified character in the media content.

In some embodiments, media integration engine 208 may dynamically update the media version of the game elements in the media content as a user profile progresses in the game. Media integration engine 208 may receive synchronization requests from game streaming platform 204 at periodic time periods or when the game streaming platform detects that a character controlled by the player profile has initiated specific gameplays or quests. The synchronization request may instruct the media integration engine 208 to update the media version of the game elements in the media content based on new or updated received game elements from the game streaming platform. For example, the media integration engine determines that a media content item contains scenes with a house in the background. The media integration engine receives a synchronization request from the game streaming platform indicating that a player within the game has set the house on fire. The synchronization request may have an API call from the game streaming platform to update the media content. In other embodiments, generative AI models may be used to perform the content update.

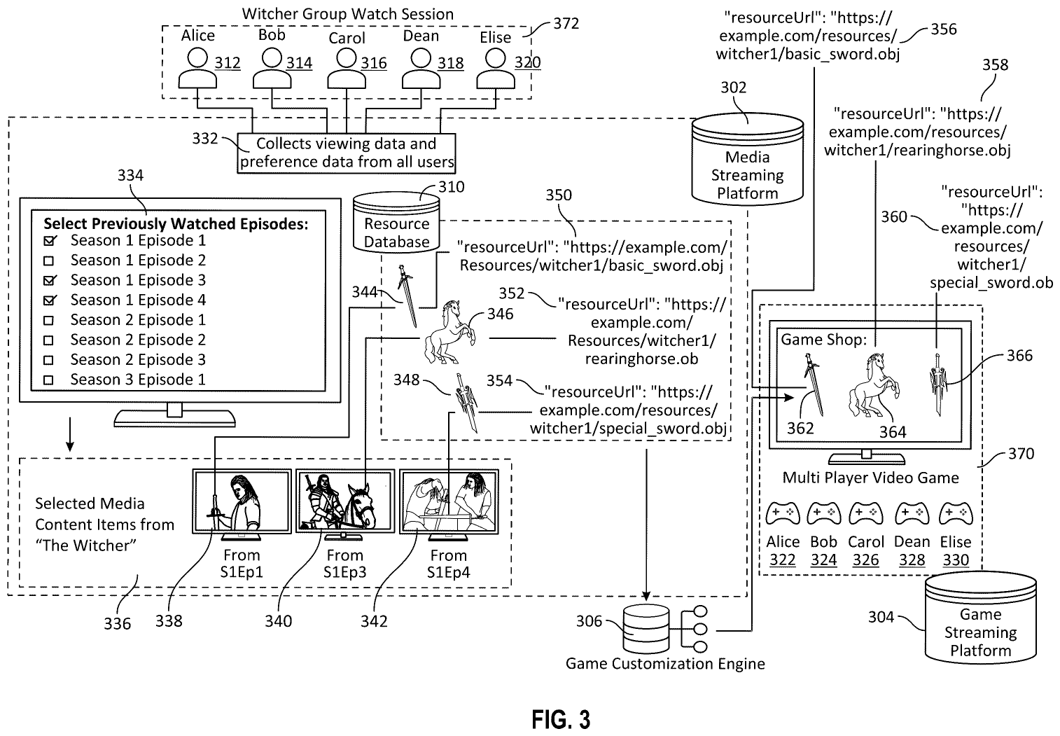

FIG. 3 shows an illustrative diagram of system 300 for customizing multi-player game session 352 on game streaming platform 304 based on elements 324, 326, and 328 from media content being streamed for multi-user watch party 354 on media streaming platform 302, in accordance with some embodiments of this disclosure. System 300 comprises of media streaming platform 302 (corresponding to media streaming platforms 102, 202, 402, 502, and 602, media content service 702, streaming service 802, and interactive media content platform 1202); game streaming platform 304 (corresponding to game streaming platforms 104, 204, 404, 504, and 604, game streaming platform hosting game 704, content updating service 804, and game streaming platform hosting game 1204); game customization engine 306 (corresponding to game customization engines 106 and 506); and gaming devices 342, 344, 346, 348, and 350 (corresponding to game player and devices 422, 424, 426, 428, and 430, and game player and devices 522, 524, 526, 528, and 530). Game customization engine 306 is communicatively coupled to media streaming platform 302 and game streaming platform 304 by way of a communication network and communication paths. The communication network may be any type of communication network, such as the Internet a mobile phone network, mobile data network (e.g., a 4G or LTE network), cable network, public switched telephone network, public cloud network, private cloud network, LAN network, WAN network, wireless network, any other communication network, or a combination thereof. The communication network includes one or more communication paths, such as a satellite path, a fiber-optic path, a cable path, a path that supports internet communications (e.g., IPTV), free-space connections (e.g., for broadcast or other wireless signals), any other suitable wired or wireless communication path, or a combination thereof.

System 300 provides media content to users 312-320 in a group watch session 372 on media streaming platform 302 (corresponding to media streaming platforms 102, 202, 402, 502, and 602, media content service 702, streaming service 802, and interactive media content platform 1202). In some embodiments, the system provides the same media content to users 312-320 through different user equipment devices, which may include, but are not limited to, a smart television, a tablet device, a smartphone, a gaming machine, a 3D headset, a virtual reality display equipment, or a set-top box or streaming device connected to a display device. Examples of media streaming platforms 302 include video-on-demand servers, streaming services, network digital video recorders, or other devices that can provide media content to users 312-320 through a group watch session 372. Examples of media content include a television program, a recording of media content, or streamed media content. In some embodiments, the system implements group watch session 372 by distributing copies of the media content to each of users 312-320 through their respective user devices. In other embodiments, the system implements group watch session 372 by streaming the media content on media streaming platform 302 in synchronous sessions accessible for user profiles associated with users 312-320. Although only one media streaming platform 302 is shown in the example of FIG. 3, in other embodiments, the system may provide users 312-320 the media content via different media streaming platforms. For example, Alice 312 may have a first user profile on a first media streaming platform configured to view the media content on a laptop, and Bob 314 may have a second user profile on a second media streaming platform configured to view the media content on a tablet. In some embodiments, the system may provide users 312-320 the media content via different media streaming services connected via a communication network. The media streaming services may include one or more types of programming sources (such as NBC, ABC, HBO, Hulu, etc.). For example, Carol 316 may have a third user profile on a first media streaming service, HBO, and Dean 318 may a fourth user profile on a second media streaming service, Hulu. The first media streaming service provides a different selection of media content than the selection provided by the second media streaming service. However, both the first media streaming service and the second media streaming service provide at least one of the same media content that will be used during the group watch session.

In some embodiments, the system collects viewing data and preference data 323 from users 312-320 through media streaming platform 302, or a combination of media streaming platforms. In another, user preferences of respective users in the group watching session are determined. For example, user preferences for one of the users 312 may be determined based on information in a user profile associated with the user 312, such as a user profile for a media player application implemented on the user's user equipment device or stored at a remote server, and/or based on other information about the user 312, such as a social media profile, posts on social media networks and/or web forums, or emails, text or chat messages sent previously by the user 312.

In another embodiment, the game customization engine sends a request to media streaming platform 302 through an API call configured to communicate between a computing server and the media streaming platform to retrieve group watch viewing history 332. For example, the request API may be as shown:

```
{
  “requestType”: “getUserViewingHistory”
  “apiKey”: “YourStreamingServiecAPIKey”
  “userID”: “UniqueUserID”
}
```

The system may receive a response 332 including viewing data and preference data 334 of a user or a group of users from the API call to media streaming platform 302. For example, the response API may be as shown:

```
  {
    “status”: “success”
    “userID”: “UniqueUserID”
    “eligibleTitles”: {
      {
        “mediaContentID”: “MediaContentID5”
        “title”: “Galactic Battles: The Quest for Zorlon”
        “type”: “Interactive Film”
        “integrationFeatures”: {
          “skins”: true;
          “maps”: false;
          “characterModels”: true;
          “narrativeElements”: true;
          “resourceURL”: “https://example.com/resources/galactic”
        }
        “availability”: “2024-04-01T00:00:00Z”
      }
      {
        “mediaContentID”: “MediaContentID8”
        “title”: “The Witcher Season 1”
        “type”: “Interactive Series”
        “integrationFeatures”: {
          “skins”: true;
          “maps”: true;
          “characterModels”: false;
          “narrativeElements”: true;
          “resourceURL”: “https://example.com/resources/witcher1”
        }
        “availability”: “2024-05-15T00:00:00Z”
        “seriesDetails”: {
          “totalEpisodes”: 10;
          “episodes”: {
            {
              “episodeID”: “Episode1”;
              “title”: “The End's Beginning”;
              “viewingProgress”: “Completed”;
            }
            {
              “episodeID”: “Episode2”;
              “title”: “The Discovery”;
              “viewingProgress”: “Four Marks”;
              “progressPercentage”: 75;
            }
            {
              “episodeID”: “Episode3”;
              “title”: “Betrayer Moon”;
              “viewingProgress”: “Not Started”;
            }
          }
        }
      }
    }
  “message”: “Eligible titles for game customization retrieved successfully.”
}
```

In some embodiments, response data 332 comprise viewing data and preference data 334. The viewing data may comprise identifiers for media content. For example, the viewing data and preference data may include a list of identifiers for movies, TV shows, or other types of media content (e.g., MediaContentID5, MediaContentID8, etc.) and their titles (e.g., “Galactic Battles: The Quest for Zorlon,” “The Witcher Season 1,” etc.). In some embodiments, viewing data and preference data 334 indicate the types of media content. For example, the viewing data and preference data may indicate that “Galactic Battles: The Quest for Zorlon” is an interactive film and that “The Witcher Season 1” is an interactive series.

In some embodiments, response data 332 comprise of viewing data and preference data 334. The viewing data may comprise identifiers for media content items. For example, the viewing data and preference data may include a list of episodes (e.g., S1Ep1, S1Ep2, S1Ep3,S1Ep4, S2Ep1, S2Ep2, S2Ep3, S3Ep1, etc.) and episode titles (e.g., “The End's Beginning,” “Four Marks,” “Betrayer Moon,” etc.) of a TV show offered on the media streaming platform. In some embodiments, viewing data and preference data 332 comprise a user's or multiple users' viewing progress of media content items. For example, the viewing data may indicate that Alice has watched the entire episode of “The End's Beginning,” that Bob has watched 75% of “The End's Beginning, or that Carol has not watched any of “The End's Beginning.”

In some embodiments, response data 332 comprise viewing data and preference data 334. The preference data may comprise data indicating certain media content items 338-342 that users 312-320 select to be integrated into video game 370. Examples of media content items include episodes of a TV show, temporal portions of media content, video installments, sections of media content, chapters, or other subsets that combine into a whole media content item. In some embodiments, the system allows a user to mark viewed content items on user interface display 334 in order to consider the marked content items for either game generation or media integration. For example, Alice and her friends have watched episodes 1-4 of season 1, episodes 1-2 of season 2, and episode 1 of season 3 of a TV show. Alice only likes a certain character's outfits in episodes 1, 3, and 4 of season 1. Alice may select only episodes 1, 3, and 4 of season 1 to be sent to the game customization engine in order to use the character's outfits in the video game instead of selecting all episodes. In another example, Alice and her friends share a single user profile on a single media streaming service. Alice may select only episodes 1, 3, and 4 of season 1 out of all the episodes extracted from the single user profile's viewing data for game integration. In yet another example, Alice selects episode 1 of season 1 and Elise selects episodes 3 and 4 of season 1 for game integration.

In some embodiments, response data 332 that is received following the server's request comprise data indicating integration features related to media content or media content items. For example, the response data may indicate that the interactive film “Galactic Battles: The Quest for Zorlon” has interactive data for skins, character models, and narrative elements that can be used for integration into a personalized dynamic video game related to “Galactic Battles” on game streaming platform 304. In another example, the response data may indicate that the interactive series “The Witcher Season 1” has interactive data for skins, maps, and narrative elements that can be used for integration into a personalized dynamic video game related to “The Witcher” on game streaming platform 304. In some embodiments, response data 332 includes a resource locator for interactive features related to media content or media content items. For example, the response data may indicate that the data for interactive features related to “Galactic Battles” may be located on resource database 310 and may be accessed through resource locator “https://example.com/resources/galactic.” In another example, the response data may indicate that the data for interactive features related to “The Witcher Season 1” may be located on resource database 310 and may be accessed through resource locator “https://example.com/resources/witcher1.” In some embodiments, each of the interactive features on resource database 310 has its individual resource locator. For example, interactive feature sword 344 from content item 338 of the TV show “The Witcher” 336 may be found on resource database 310 through resource locator 350. Interactive feature horse 346 from content item 340 of content 336 may be found on resource database 310 through resource locator 352 and interactive feature sword 348 from content item 342 of content 336 may be found on resource database 310 through resource locator 354.

In some embodiments, the system accesses resource database 310 containing data related to interactive elements from media streaming platform 302. The system identifies media elements such as characters, settings, and plot points from the selected media content items for game customization. In other embodiments, resource database 310 is on a server separate from the media streaming platform and communicates to the media streaming platform through a communication network. The system identifies media elements 344, 346, and 348 in resource database 310 which are related to selected media content items 338, 340, and 342, respectively. In one embodiment, the system determines that the media elements are related to the selected media content items based on the media elements' metadata in the resource database. The system may conduct a search in the resource database to find media elements wherein the media elements' metadata indicates the media content item. For example, the system searches for media elements that are labeled with episode 1 of season 1 of the TV show “The Witcher.” In another embodiment, the system determines that the media elements are related to the selected media content items by identifying each media element from a frame of a selected media content item using object recognition software.

In some embodiments, resource database 310 comprises of object files representing media elements 338, 340, and 342 from media content items 344, 346, and 348, respectively. For example, the resource database may be preloaded with game object files for each of the media elements that may be seamlessly incorporated into video games developed with the same file type as the preloaded objects. In other embodiments, resource database 310 comprises of resource locators 350, 352, and 354 for media elements 344, 346, and 348, respectively. In one example, the game customization engine may take in the resource locators as input and retrieve the relevant game object files from a separate server. In another example, the game customization engine may take in the resource locators as input and retrieve the relevant game object files from a location on resource database 310.

In some embodiments, game customization engine 306 may retrieve the title, episode, or series information, as well as the viewing progress, user preferences 334, available integration features or game objects 362, 364, and 366, and resource locators 356, 358, and 360 for the retrieval of integration features or game objects, from response data 332.

Gaming devices 322, 324, 326, 328, and 330 may be any type of gaming devices or gaming system, such as gaming consoles (e.g., PS5, Xbox, Nintendo Switch), handheld consoles (e.g., Nintendo DS), personal computers, mobile devices, VR devices, AR devices, arcade machines, smart TVs, streaming devices, wearable devices, any other type of gaming console, or a combination thereof.

In some embodiments, game customization engine 306 may send to game streaming platform 304 the resource locators 356, 358, and 360 for media elements that may be incorporated into the video game. Game streaming platform 304 accesses file types of resources 362, 364, and 366 that correspond to the video game. In some embodiments, game streaming platform 304 integrates resources 362, 364, and 366 into the game world of multi-player video game 370. In other embodiments, game streaming platform 304 inserts the resources into a game shop, as shown in FIG. 3. The game streaming platform may receive input from either one or a multiple of devices 322, 324, 326, 328 and 330 indicating a selection of one of the resources in the game shop. The selected resources may be used in integration into the video game.

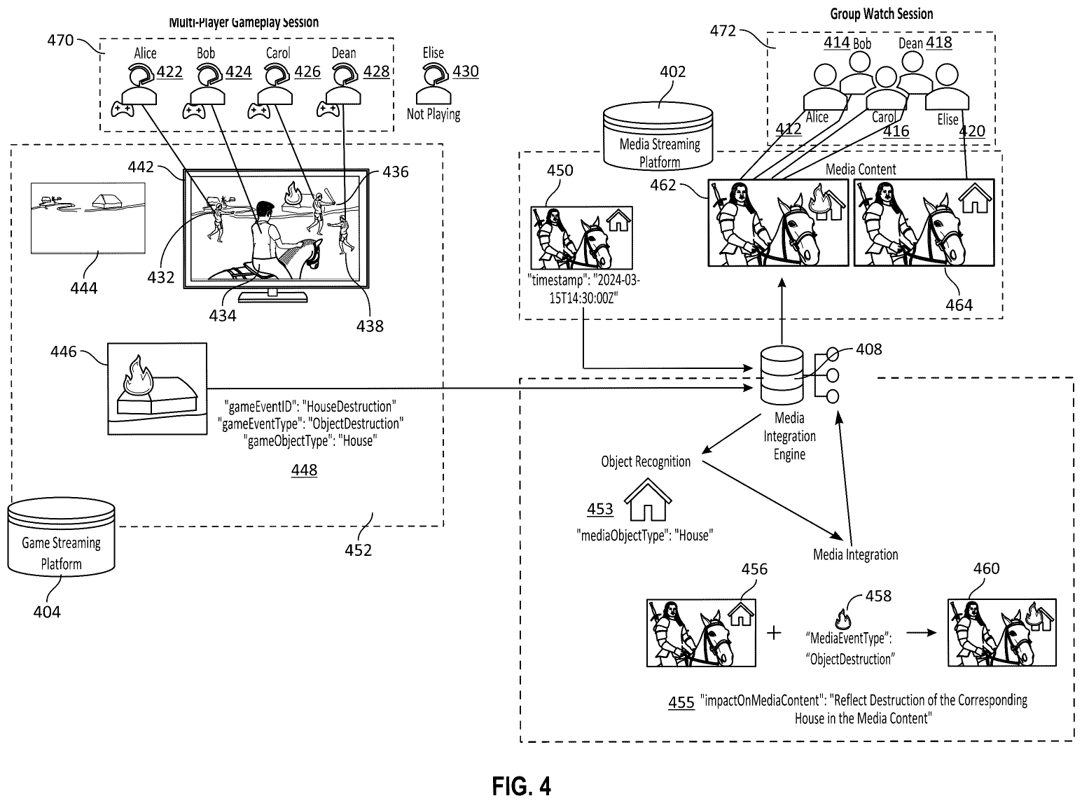

FIG. 4 shows an illustrative diagram of system 400 for integrating game elements 446 from multi-player game session 470 on game streaming platform 404 into media content 450 of multi-user watch party 472, in accordance with some embodiments of this disclosure. System 400 comprises of media streaming platform 402 (corresponding to media streaming platforms 102, 202, and 302); game streaming platform 404 (corresponding to game streaming platforms 104, 204, and 304); media integration engine 408 (corresponding to media integration engine 208); game player and device 422 (corresponding to gaming device 322); game player and device 424 (corresponding to gaming device 324); game player and device 426 (corresponding to gaming device 326); and game player and device 428 (corresponding to gaming device 328). Media integration engine 408 is communicatively coupled to media streaming platform 402 and game streaming platform 404 by way of a communication network and communication paths, similar to the disclosed embodiments of FIG. 3.

System 400 enables players 422, 424, 426, and 428 to engage in multi-player gameplay session 470 on game streaming platform 404. In some embodiments, the system provides multi-player gameplay session 470 on the same game streaming platform for all players. For example, Alice, Bob, Carol, and Dean may play Mario Kart together in the same room on separate Nintendo Switch remotes connected to a single Nintendo Switch console logged under Alice's user profile. In another example, Alice, Bob, Carol, and Dean may play Mario Kart together in separate locations on separate Nintendo Switch remotes under distinct user profiles through wireless or Internet connection. In other embodiments, the system provides multi-player gameplay session 470 on a different game streaming platform such as in cross-platform gaming. For example, Alice and Bob may be playing a multi-player gaming session together, but Alice is playing from an Xbox console and Bob is playing from a PlayStation console.

In some embodiments, the system populates the game world 444 of video game 442 with integrated digital characters 432, 434, 436, and 438 representing players 422, 424, 426, and 428 engaging in multi-player gameplay session 470. For example, Alice's game controller may receive user input to move Alice's game character 432 by running across the game field. In another example, Carol's game controller may receive user input to have Carol's game character 436 interact with game world elements, such as destroying a house within the game world.

In other examples, a 3D camera or infrared device may be attached to the gaming system on which game streaming platform 404 is hosted. The 3D camera or infrared device may use object recognition to identify Dean's body within a room. The 3D camera or infrared device may recognize Dean's body motion and configure his game character 438 to move in a similar motion within the game world 444.

In some embodiments, game streaming platform 404 comprises a game object database for elements within game world 444 that may be modified by actions done by game characters. For example, the game object database may include references to objects within the game that may be modified by a player, such as houses, food items, weapons, grass, roads, trees, buildings, non-animate objects, animate objects, and other types of interactive elements within the game.

In some embodiments, game streaming platform 404 identifies that the device for player 426, who is controlling game character 436, receives input corresponding to game character 436 modifying an interactive element in the game. For example, the game streaming platform may determine that a player has destroyed a house object in the game world by receiving input from the player's gaming device prompting the player's game character to destroy a visual of the house object in the video game.

In some embodiments, game streaming platform 404 sends a request to the game customization engine to modify an interactive element within the game. For example, the game streaming platform detects that a player has destroyed a house object in the game world. The request includes instructions 448 regarding the interactive element and the action done upon the interactive element. For example, the game streaming platform sends an API request to the game customization engine as shown:

```
“gameplayEvents”: {
  “eventID”: “HouseDestruction”;
  “eventType”: “ObjectDestruction”;
  “objectType”: “House”;
  “description”: “User burned a house in the game”
}
```

The game customization engine then updates the video game 442 to include the modification to the interactive element 446. For example, the game customization engine replaces the original house object in the game world with a copy of the house object, wherein the copy is engulfed in flames. The game customization engine then receives a synchronization request from the video game platform to update the video game to have the house engulfed in flames.

In some embodiments, game streaming platform 404 sends an API call to media integration engine 408 to update media content to include the gameplay event similar to the request sent to the game customization engine as described in the preceding paragraph.

In some embodiments, media integration engine 408 receives a request to update media content with instructions regarding the gameplay event. Media integration engine 408 may use an object recognition algorithm or another image recognition service (corresponding to image recognition service 810) to identify media element 453 from media content 450 that is instructed to be modified from the received request. For example, the media integration engine may receive an instruction to update a house in the media content because the house was destroyed by players in the video game session. The media integration engine may pass the media content into an image recognition service to identify the house.

In some embodiments, media integration engine 408 accesses a database of media events to retrieve modification instructions 458 of media element 453. For example, the media integration engine 408 retrieves code instructions under “mediaEventType”: “ObjectDestruction” to modify the visual of the house to include flames indicating that the house has been destroyed. In other embodiments, media integration engine 408 uses generative artificial intelligence to update the house to include flames.

In some embodiments, media integration engine 408 receives input of a scene 456 and modifies the object 453 using modification instructions 458 to generate a scene 460 wherein the object has been modified. The modification may have additional metadata 455 describing the modification that may be logged in a modification history stored on the media integration engine or media streaming platform.

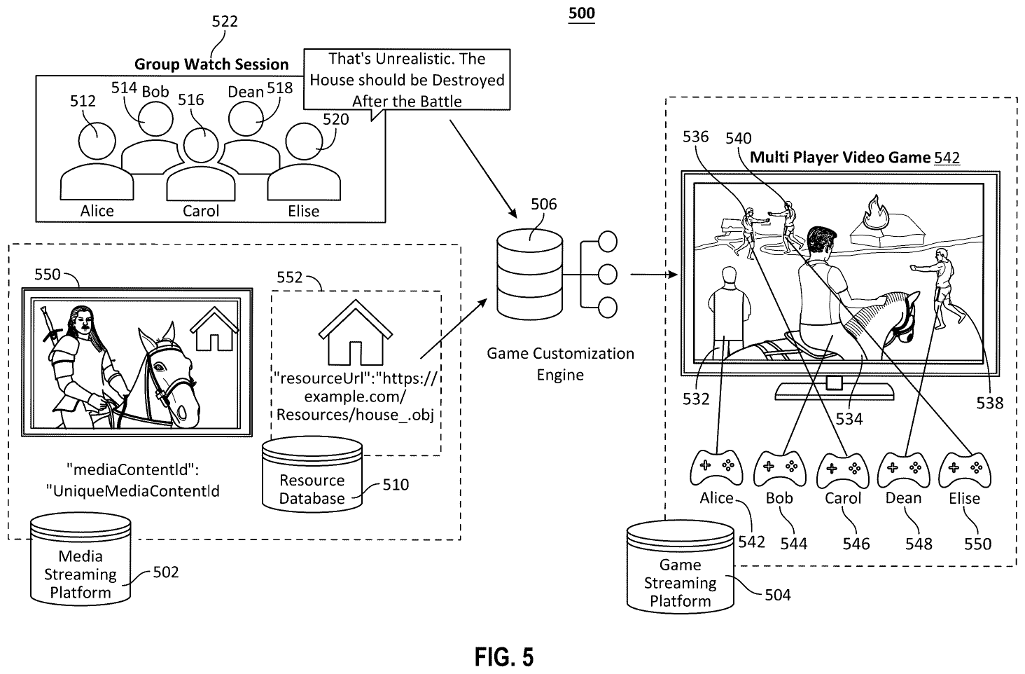

FIG. 5 shows a system diagram for customizing a multi-player game session 570 (corresponding to multi-player game sessions 370 and 470) based on received commentary 522 from one of users 512, 514, 516, 518, and 520 in a multi-user watch party 572 (corresponding to users 312, 314, 316, 318, and 320 in multi-user watch party 372, and users 412, 414, 416, 418, and 420 in multi-user watch party 472), in accordance with some embodiments of this disclosure. System 500 comprises of media streaming platform 502 (corresponding to media streaming platforms 102, 202, 302, 402, and 602, media content service 702, streaming service 802, and interactive media content platform 1202); game streaming platform 504 (corresponding to game streaming platforms 104, 204, 304, 404, and 604, game streaming platform hosting game 704, content updating service 804, and game streaming platform hosting game 1204); game customization engine 506 (corresponding to game customization engines 106, 306, 606, 706, 806, 906, and 1106, and game generation engine 1206); resource database 510 (corresponding to resource database 310); game player and device 522 (corresponding to gaming devices 322 and 422); game player and device 524 (corresponding to gaming devices 324 and 424); game player and device 526 (corresponding to gaming devices 326 and 426); game player and device 528 (corresponding to gaming devices 328 and 428), and game player and device 530 (corresponding to gaming devices 330 and 430). Game customization engine 506 is communicatively coupled to media streaming platform 502 and game streaming platform 504 by way of a communication network and communication paths, similar to the disclosed embodiments of FIG. 1 and FIG. 3.

In some embodiments, game customization engine 506 receives commentary data 522 from multi-user watch party 572 on media streaming platform 502. Some examples of commentary data may include data indicative of text messages between users 512, 514, 516, 518, and 520 of multi-user watch party 572, transcribed voice conversations between the users, or other types of communication between the users during the watch party. In one example, the game customization engine may receive commentary data that indicates users' desire for an event in the media content not to have happened. In another example, game customization engine 506 may receive text data 522 that was sent from user 520 on a user device to the multi-user watch party interface on media streaming platform 502 that the user believes that the scene in the media content is “unrealistic” and that an object in the scene should be “destroyed after the battle.” Game customization engine 506 may alter the game based on the interactivity and the received commentary data during the multi-user watch party that are related to the storyline. In some embodiments, game customization engine 506 may alter the game based on the received commentary data that discusses media elements that correlate to game elements. In some embodiments, commentary data 522 may comprise of a wishlist accessible to all user profiles in multi-user watch party 572. Media streaming platform 502 may receive input from devices corresponding to the user profiles in multi-user watch party 572 indicating a selection of events or actions in the wish-list. Game customization engine 506 may alter the game based on the events or actions in the wish-list. In other embodiments, game customization engine 506 may generate a new multi-player game instead of simply altering the occurring multi-player game.

In the example shown in FIG. 5, game customization engine 506 receives commentary data 552 indicating that a house shown in media content 550 “should be destroyed after the battle.” Game customization engine 506 may pass the received commentary data into a semantic analysis algorithm and/or a sentiment analysis algorithm to determine the contextual meaning behind the commentary data. The semantic analysis algorithm and/or the sentiment analysis algorithm may indicate to game customization engine 506 that the users in the multi-user watch party wish to alter media-element 552 in the media content.

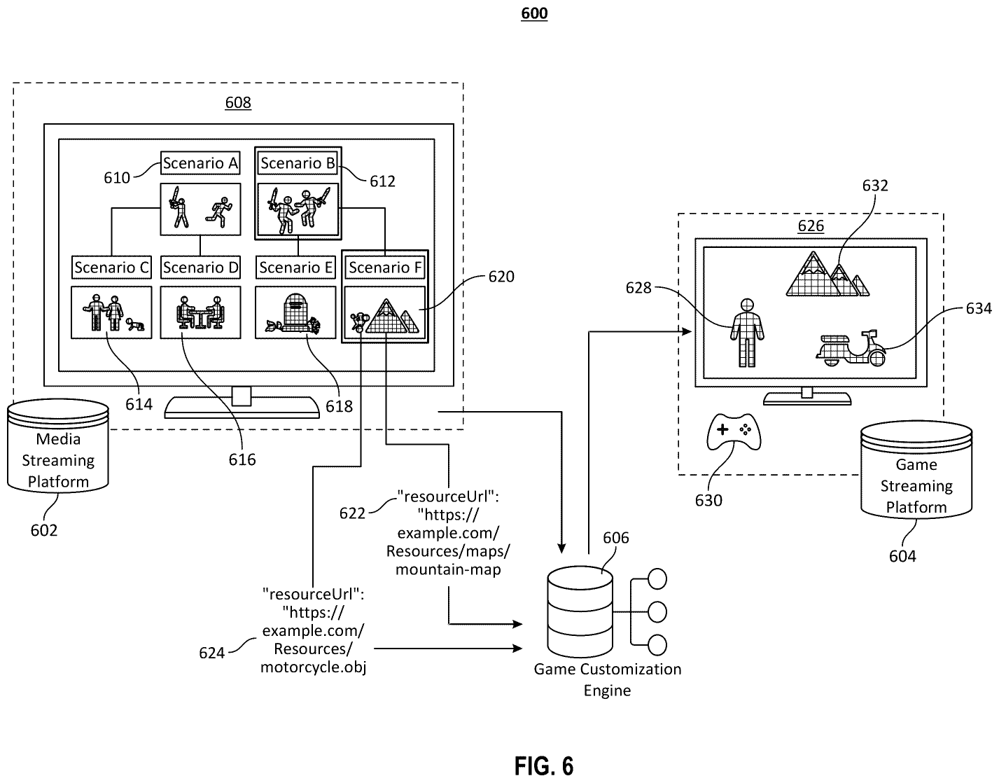

FIG. 6 shows an illustrative integration application system 600 for customizing game content based on consumption of media of a user profile, in accordance with some embodiments of the present disclosure. In some embodiments the media streaming platform 602 provides interactive media (e.g., selecting plots/scenarios) while consuming an episode 608. While consuming an episode the media streaming platform in some embodiments may offer a selection to the end user by offering a plurality of options for the user profile to select. In the non-limiting example, of FIG. 6 two scenarios are offered scenario A 610, flee from battle; scenario B 612, fight the battle. The media streaming platform registers that scenario B 612 was selected by the end user on a user device.

In some embodiments, selecting parent scenario(s) (e.g., scenario A, and scenario B) triggers the media streaming platform to generate children scenario(s) (e.g., scenario C, scenario D, scenario E, scenario F). Each scenario of the media content comprises unique elements different from one another. For example, selecting scenario B (e.g., to fight) causes a character in the exemplary episode to either die (e.g., scenario E 618) or live (e.g., scenario F 620) and ascend a mountain. Selecting the scenarios on the media streaming platform 602, causes metadata from the unique scenario to be sent to an intermediate server (e.g., game customization engine 606). In some embodiments metadata are resources URLs (e.g., “resourceUrl”: “https://example.com/Resources/maps/mountain-map 622, “resourceUrl”: “https://example.com/Resources/motorcycle.obj 624).

In the non-limiting example of FIG. 6, plot points (i.e., scenario B and scenario F) are selected in an episode. The plot points correlate to unique metadata comprising a plurality of resources to be sent to game customization engine 606. The unique metadata is populated in game session 262 of game application 630 hosted on game streaming platform 604. For example, because scenario F was chosen instead of E, the character from chosen scenario B did not die, and consequently the character 628 becomes available in the gameplay session. Additionally, quest 632 and object 634 (e.g., motorcycle) becomes available in the gameplay session due to the selection of linked plot points B 612 and F 620.

In some embodiments, resources are sent by the media streaming platform to the game customization engine triggered by the user device selecting the scenarios. In other embodiments, the resources are sent to the game customization engine once the media streaming platform identifies that the entire media item (e.g., episode) is consumed by a user profile. In some embodiments, the resources are sent once the user profile reaches a consumed time threshold of the episode.

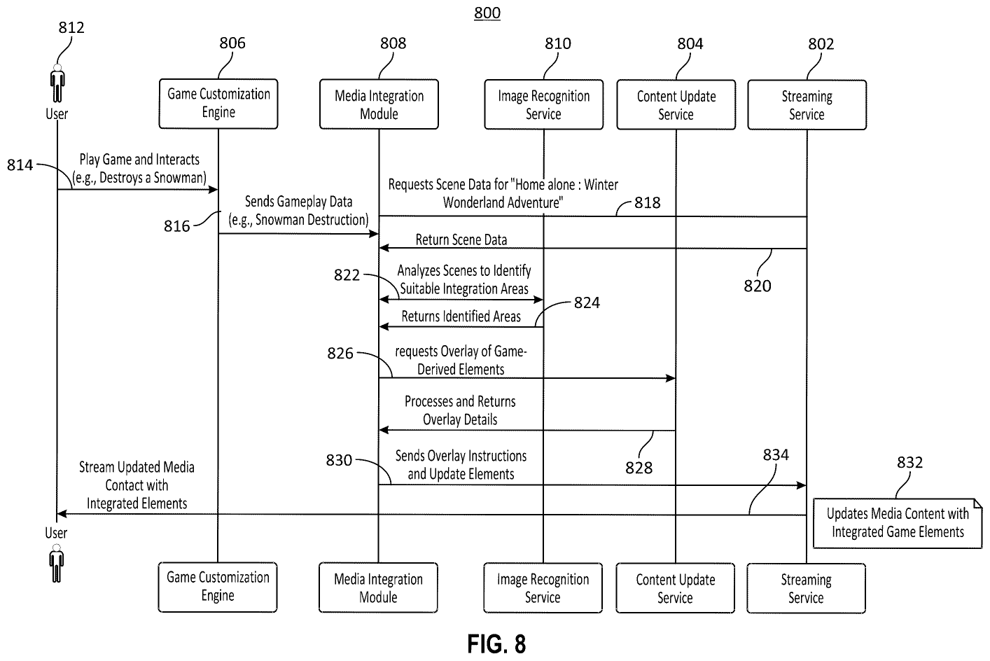

FIG. 7 depicts a bi-directional sequence diagram 700 for generating personalized video games 704 based on an individual player's progress in viewing associated media content, in accordance with some embodiments of this disclosure. As previously mentioned, the integration application not only generates game content based on the user's media consumption but also integrates elements from the game back into the media content consumed by the user profile 712. This embodiment features five primary actors: user 712, media content service 702, media analysis module 708, game customization engine 706 and game 704.

In the example of FIG. 7 of the system 700, the user profile watches media (e.g., series, movies, episodes) provided by a media content service provider (e.g., Netflix, Hulu, Amazon, Comcast etc.). The media content service 702 sends viewing history 718 to media analysis module 708. Media analysis module 708 utilizes NLP, ML, computer vision, generative AI, LLMs 720 to analyze content 722 to generate game content ideas 724 (e.g., plots, characters, objects, levels, skins etc.). The generated content 724 is then sent to game customization engine 706 which uses development tools and libraries to create/update game content 726 and updates game 704 with new content reflecting the user's media consumption 728.

In some embodiments the game customization engine updates specific game model (e.g., API response) 738 to the game 704. The user profile 712 plays the game 704 with content based on the viewed media 730. In some embodiments, the media content service 702 calls API (e.g., getGameCustomizationOptision) 732 to the game customization engine 706. The game customization engine 706 responds with customization outputs (e.g., API response) 734. The media content service 702 calls API back to the game customization engine 706 with gameID (e.g., updateGameModel) 736.

FIG. 8 depicts a bi-directional sequence diagram 800 for generating personalized media content based on a user profile 812 gameplay session, in accordance with some embodiments of this disclosure.

At 812, a user profile logs in to the integration system's game customization engine and a game application (e.g., Xbox, Steam, Netflix, etc.)

At 814, the user profile interacts with game elements in a game application (e.g., destroys snowman) the data comprising the destroyed snow man is sent 816 (e.g., SnowmanDestruction) to the game customization engine 806.

The media integration module 808, on a separate server hosting the game application, requests scene data for “Home Alone: Winter Wonderland Adventure” to the media streaming service 802, which returns scene data 820 to the media integration module 808. An image recognition service 810 analyzes the scene data to identify suitable integration areas 822 and returns identified areas 824 to the media integration module 808. The media integration module 808 requests overlay of game-derived elements 826 to a content update service 804 which processes and returns overlay details 828 back to the media integration module 808. The media integration module sends the overlay instructions and updated elements 830 to the streaming service 802. The streaming service updates media content with integrated game elements 832 to be consumed by a user profile. The user profile 812 streams updated media content with integrated elements 834.

The following is an example API call to the media integration module to update a media content based on a user's gameplay:

```
{
    “requestType”: “updateMediaContentBasedOnGameplay”,
  “apiKey”: “GameEngineAPIKey”,
    “gameID”: “UniqueGameID456”,
  “userID”: “UniqueUserID789”,
    “mediaContentId”: “UniqueMediaContentId789”,
    “title”: “Home Alone: Winter Wonderland Adventure”,
    “gameplayEvents”:{
    “eventID”: “SnowmanDestruction”,
    “eventType”: “ObjectDestruction”,
    “objectType”: “Snowman”,
    “description”: “User destroyed a snowman in the game”,
    “timestamp”: “2024-03-15T14:30:00Z”,
      “impactOnMediaContent”: “Reflect destruction of the corresponding
  snowman in the media content”
  }
}
```

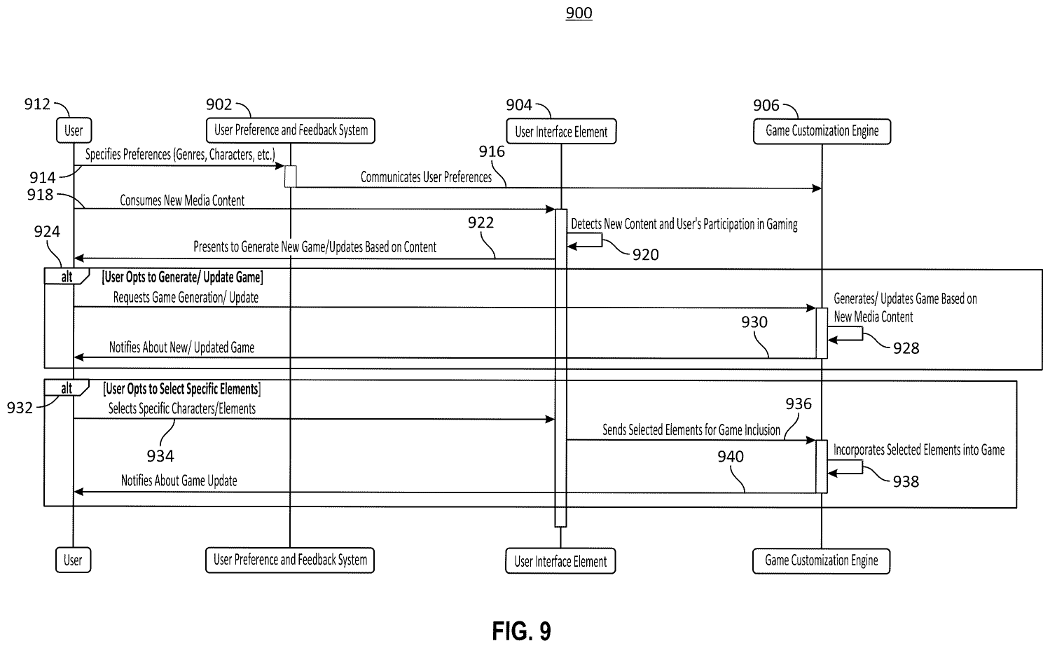

FIG. 9 shows an illustrative flowchart of system 900 for describing a user preference and feedback system to specify types of media elements to implement in game content, in accordance with some embodiments of this disclosure.

At 914, user preference and feedback system 902 receives specific preferences (e.g., genres, characters, etc.) from a user profile 912 on a media streaming platform.

At 916, user preference and feedback system 902 sends a communication of the user preferences to game customization engine 906.

At 918, user interface element 904 receives data from user profile 912 indicating that the user has consumed new media content.

At 920, user interface element 904 identifies the new media content consumed by user profile 912. User interface element 904 determines that user profile 912 is associated with a gameplay session of a video game related to the new media content.

At 922, user interface element 904 presents options for display for user profile 912 to generate a new game or update the current gameplay session based on the new media content.

In some embodiments, such as at 924, user interface element 904 receives a user input associated with user profile 912 to generate a new game or update the current game based on the new media content.

In some embodiments, such as at 926, game customization engine 906 receives a request to generate or update a game from user profile 912.

In some embodiments, such as at 928, game customization engine 906 generates or updates the game based on new media content.

In some embodiments, such as at 930, game customization engine 906 sends a notification to user profile 912 to indicate that there is a new or updated game.

In some embodiments, such as at 932, user interface element 904 receives a user input associated with user profile 912 to select specific media elements from the new media content to integrate into the game.

In some embodiments, such as at 934, user interface element 904 receives a selection of specific characters or media elements by a user through user profile 912.

In some embodiments, such as at 936, game customization 906 receives the selection of the specific characters or media elements from user interface element 904.

In some embodiments, such as at 938, game customization engine 906 incorporates the selected specific characters or media elements into the game.

In some embodiments, such at 940, game customization engine 906 sends a notification to user profile 912 to indicate that there is an update in the game.

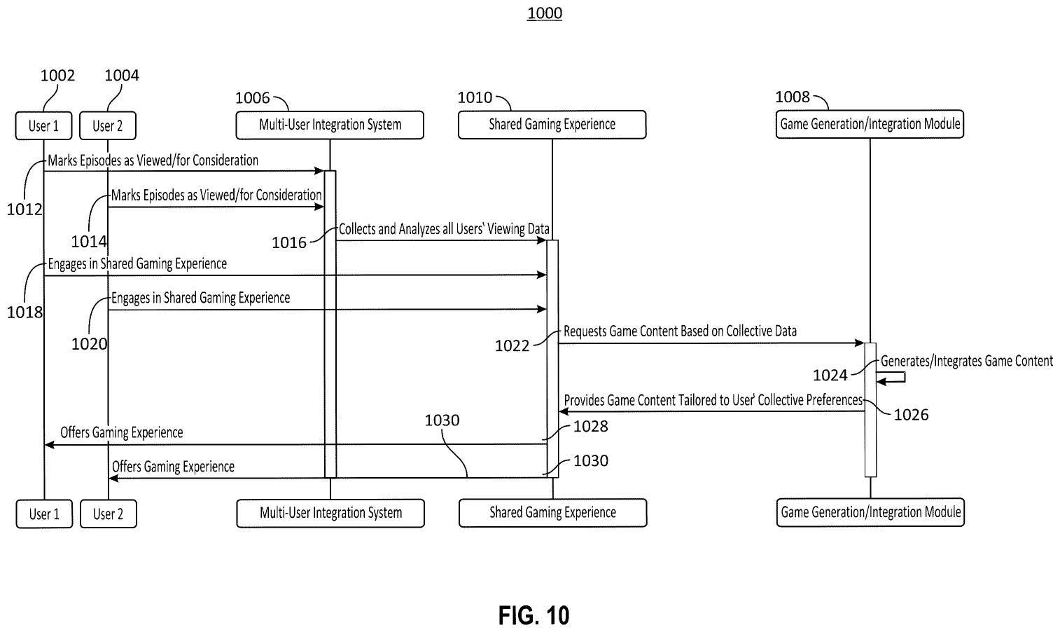

FIG. 10 shows an illustrative flowchart describing a multi-use integration system for shared gaming or content viewing experiences, in accordance with some embodiments of this disclosure.

In one embodiment, such as at 1012, a user device for a first user 1002 receives input from the first user indicating a first selection of media content items. The user device for the first user 1002 sends the first selection of media content items to multi-user integration system 1006.

In another embodiment, such as at 1012, a user device for a first user 1002 receives input indicating a first viewing data of media content items (e.g., “episodes received”) of the first user. The user device for the first user 1002 sends the first viewing data of media content items to multi-user integration system 1006.

In one embodiment, such as at 1014, a user device for a second user 1004 receives input from the second user indicating a second selection of media content items. The user device for the second user 1004 sends the second selection of media content items to multi-user integration system 1006.

In another embodiment, such as at 1014, a user device for a second user 1004 receives input indicating a second viewing data of media content items of the first user. The user device for the second user 1004 sends the first viewing data of media content items (e.g., episodes marked as viewed/consumed) to multi-user integration system 1006.

At 1016, multi-user integration system 1006 collects and analyzes the first viewing data and the second viewing data, or the first selection of media content items and the second selection of media content items, and sends a collective data file compiling all of the first viewing data and the second viewing data, or the first selection and the second selection, to shared gaming experience 1008.

At 1018, the user device for the first user 1002 initiates a shared gameplay session on shared gaming experience 1010.

At 1020, the user device for the second user 1004 engages in the shared gameplay session initiated by the user device for the first user 1002 on shared gaming experience 1010.

In one embodiment, such as at 1022, shared gaming experience 1010 sends a request for game content based on the collective data file from multi-user integration system 1006 to game generation engine 1008.

In another embodiment, such as at 1022, shared gaming experience 1010 sends a request for game content based on the collective data file from multi-user integration system 1006 to media integration engine 1008.

In one embodiment, such as at 1024, game generation engine 1008 generates game content based on media elements from the collective data file from multi-user integration system 1006.

In another embodiment, such as at 1024, media integration module 1008 integrates game content based on media elements from the collective data file from multi-user integration system 1006 to the shared gameplay session on shared gaming experience 1010.

At 1026, game generation engine or media integration module 1008 provides the generated or integrated game content to shared gaming experience 1010.

At 1028, shared gaming experience 1010 synchs the shared gameplay session and sends the newly synchronized gameplay session to the user device for the first user 1002.

At 1030, shared gaming experience 1010 sends the newly synchronized gameplay session to the user device for the second user 1004.

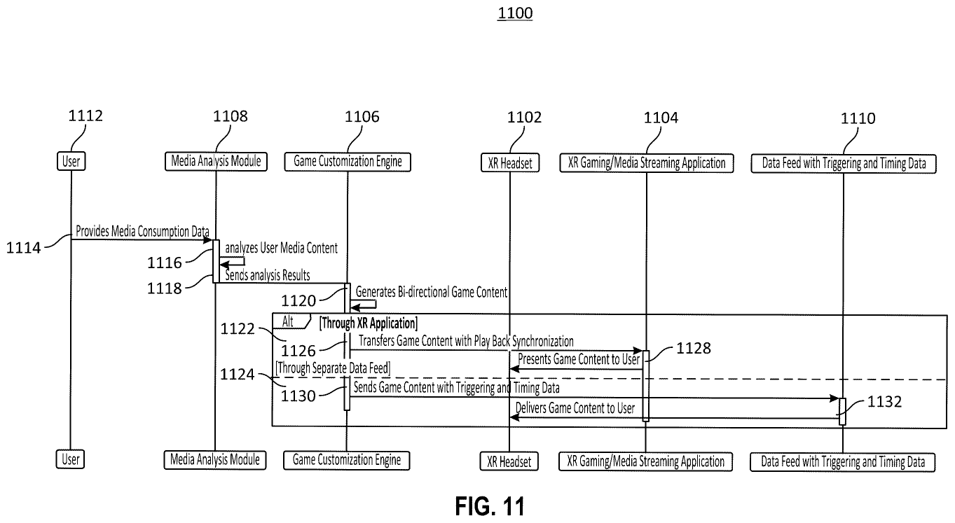

FIG. 11 shows an illustrative flowchart describing generated game content presented to a user wearing an XR headset, in accordance with some embodiments of this disclosure.

At 1114, media analysis application 1108 receives consumption data of a user from user device 1112.

At 1116, media analysis module 1108 analyzes the media content of consumed media by the user from user device 1112 from the consumption data.

At 1118, media analysis application 1108 sends results of the analysis to game customization engine 1106. For example, the media analysis application may send to the game customization engine data indicating media elements extracted from the media content that can be used for integration into a video game.

At 1120, game customization engine 1106 generates bi-directional game content based on the elements received from the media content analysis from media analysis application 1108.

In some embodiments, such as at 1122, game customization engine 1106 sends a synchronization request to XR gaming application or other media streaming application 1104 to update a gameplay session.

In some embodiments, such as at 1126, game customization engine 1106 transfers the generated game content with playback synchronization to XR application or other media streaming application 1104.

In some embodiments, such as at 1128, XR application or other media streaming application 1104 presents to the user the generated game content with playback synchronization for display through XR headset 1102 or through any other media streaming device.

In other embodiments, such as at 1124, game customization engine 1106 sends a synchronization request to data feed 1110 to update a gameplay session.

In similar embodiments, such as at 1130, game customization engine 1106 sends game content with triggering and timing data to data feed 1110.

In similar embodiments, such as at 1132, data feed 1110 presents to the user generated game content with triggering and timing data for display through XR headset 1102 or through any other media streaming device.

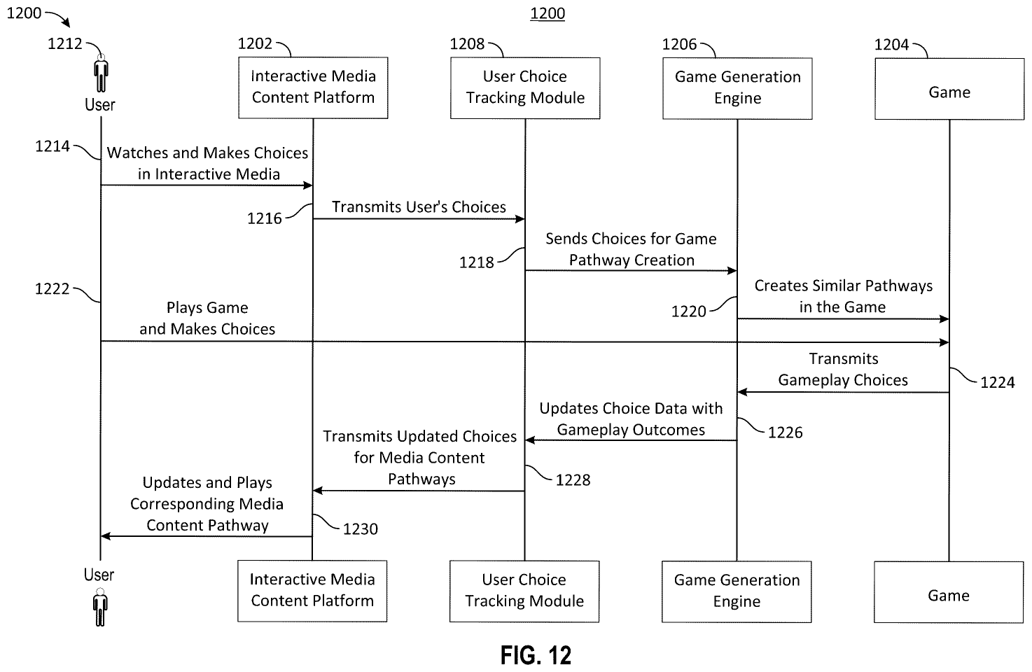

FIG. 12 shows an illustrative flowchart of a system to generate personalized video games based on a user's progress in viewing media content, in accordance with some embodiments of this disclosure.

At 1214, interactive media content platform 1202 receives user data from user device 1212 indicating selections made by a user in an interactive media session.

At 1216, interactive media content platform 1216 transmits the user data received from user device 1212 to user choice tracking module 1208. User choice tracking application 1208 receives a decision tree data structure from media content platform 1216, wherein each node in the decision tree data structure represents a narrative selection in the interactive media. User choice tracking application 1208 compares user data received from user device 1216 to the decision tree data structure received from media content platform 1216 to identify choices for game pathway creation.

At 1218, user choice tracking application 1208 sends the identified choices for game pathway creation to game generation engine 1206.

At 1220, game generation engine 1206 generates game content based on the identified choices for game pathway creation received from user choice tracking application 1208. Game generation engine 1206 integrates the generated game pathways into video game 1204.

At 1222, a device running video game 1204 receives user input from user device 1212 indicating a selection of a gameplay choice in the game content. The device running video game 1204 updates the selection of the choice to the game server or game streaming platform hosting video game 1204.

At 1224, the game server or game streaming platform hosting video game 1204 transmits data indicating the selection of the gameplay choice to game generation engine 1206.

At 1226, game generation engine 1206 updates the decision tree data structure to include the selection of the gameplay choice received at the game server or game streaming platform hosting video game 1204. Game generation engine 1206 sends the updated decision tree data structure to user choice tracking application 1208.

At 1228, application 1208 reads the updated decision tree data structure received from game generation engine 1206 and identifies the updated node with data indicating the selection of the gameplay choice. Application 1208 sends the updated node with data indicating the selection to interactive media content platform 1230.

At 1230, interactive media content platform 1230 updates the interactive media to resume playback of a portion of the media content corresponding to the node indicating the selection. Interactive media content platform 1230 displays the playback of the portion to user device 1212.

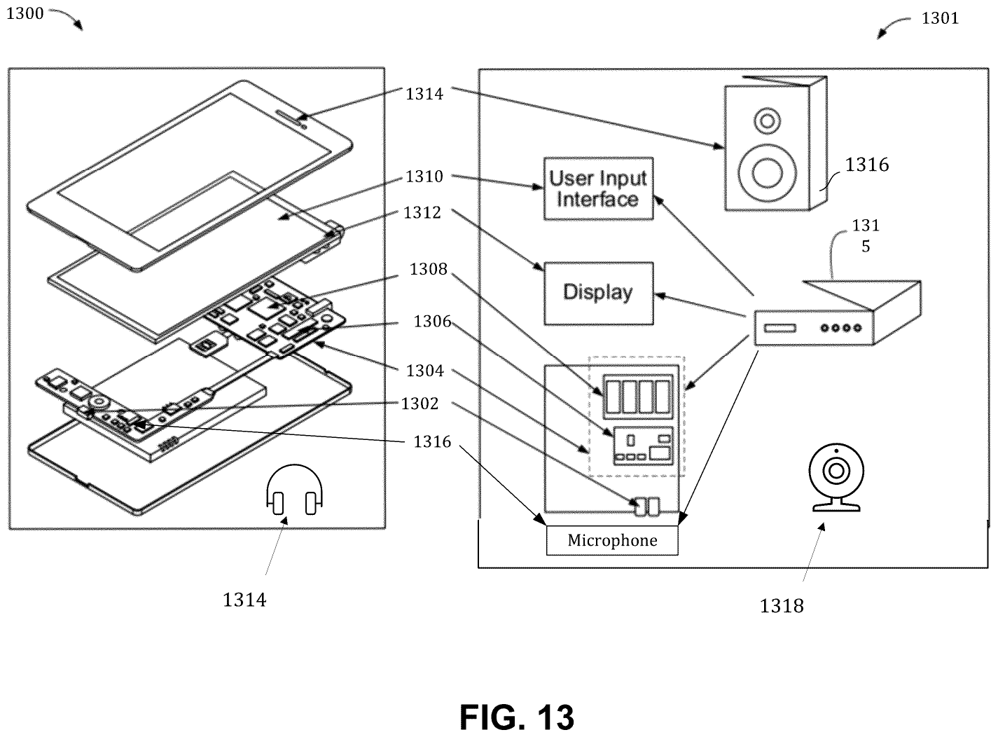

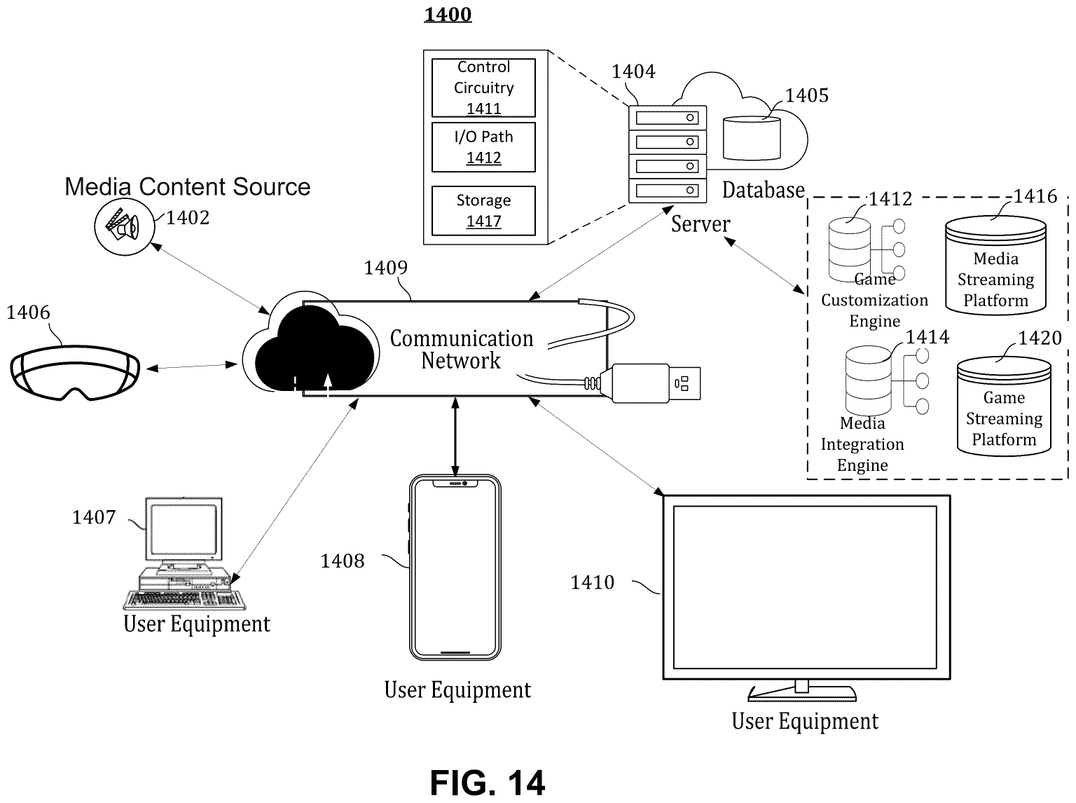

FIGS. 13-14 describe illustrative devices, systems, servers, and related hardware for providing audio from a live event to a user, in accordance with some embodiments of the present disclosure. FIG. 13 shows generalized embodiments of illustrative user equipment 1300 and 1301, which may correspond to, e.g., system integration application 100 and 200 of FIGS. 1-2. For example, user equipment 1300 may be a smartphone device, a tablet, a near-eye display device, an XR device, or any other suitable device capable of participating in a XR environment, e.g., locally or over a communication network. In another example, user equipment 1301 may be a user television equipment system or device. User equipment 1301 may include set-top box 1316. Set-top box 1316 may be communicatively connected to microphone 1317, audio output equipment (e.g., speaker or headphones 1314), and display 1312. In some embodiments, microphone 1317 may receive audio corresponding to a voice of a video conference participant and/or ambient audio data during a video conference. In some embodiments, display 1312 may be a television display or a computer display. In some embodiments, set-top box 1316 may be communicatively connected to user input interface 1310. In some embodiments, user input interface 1310 may be a remote-control device. Set-top box 1316 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 13. In some embodiments, device 1300 may comprise any suitable number of sensors (e.g., gyroscope or gyrometer, or accelerometer, etc.), and/or a GPS module (e.g., in communication with one or more servers and/or cell towers and/or satellites) to ascertain a location of device 1300. In some embodiments, device 1300 comprises a rechargeable battery that is configured to provide power to the components of the device.

Each one of user equipment 1300 and user equipment 1301 may receive content and data via input/output (I/O) path 1302. I/O path 1302 may provide content (e.g., broadcast programming, on-demand programming, internet content, content available over a local area network (LAN) or wide area network (WAN), and/or other content) and data to control circuitry 1304, which may comprise processing circuitry 1307 and storage 1308. Control circuitry 1304 may be used to send and receive commands, requests, and other suitable data using I/O path 1302, which may comprise I/O circuitry. I/O path 1302 may connect control circuitry 1304 (and specifically processing circuitry 1307) to one or more communications paths (described below). I/O functions may be provided by one or more of these communications paths, but are shown as a single path in FIG. 13 to avoid overcomplicating the drawing. While set-top box 1316 is shown in FIG. 13 for illustration, any suitable computing device having processing circuitry, control circuitry, and storage may be used in accordance with the present disclosure. For example, set-top box 1316 may be replaced by, or complemented by, a personal computer (e.g., a notebook, a laptop, a desktop), a smartphone (e.g., device 1300), an XR device, a tablet, a network-based server hosting a user-accessible client device, a non-user-owned device, any other suitable device, or any combination thereof.

Control circuitry 1304 may be based on any suitable control circuitry such as processing circuitry 1307. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 1304 executes instructions for the media application stored in memory (e.g., storage 1308). Specifically, control circuitry 1304 may be instructed by the media application to perform the functions discussed above and below. In some implementations, processing or actions performed by control circuitry 1304 may be based on instructions received from the media application.

In client/server-based embodiments, control circuitry 1304 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 13, the instructions may be stored in storage 1308, and executed by control circuitry 1304 of a device 1300.

In some embodiments, the media application and/or system integration application may be a client/server application where only the client application resides on device 1300, and a server application resides on an external server (e.g., server 1404 and/or media content source 1402). For example, the media application and/or system integration application may be implemented partially as a client application on control circuitry 1304 of device 1300 and partially on server 1404 as a server application running on control circuitry 1411. Server 1404 may be a part of a local area network with one or more of devices 1300, 1301 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 1404 and/or an edge computing device), referred to as “the cloud.” Device 1300 may be a cloud client that relies on the cloud computing capabilities from server 1404 to generate personalized engagement options in a VR environment. The client application may instruct control circuitry 1304 to generate personalized engagement options in a VR environment.

In some embodiments, the media application and/or system integration application comprises an intermediate server (i.e., game customization engine 1412) that communicatively couples a media streaming platform server 1416 to a game streaming platform server 1420. In other embodiments, the media application and/or system integration application comprises an intermediate server (i.e., media integration engine 1414) that communicatively couples a game streaming platform server 1420 to a media streaming platform server 1416.

Control circuitry 1304 may include communications circuitry suitable for communicating with a server, edge computing systems and devices, a table or database server, or other networks or servers. The instructions for carrying out the above mentioned functionality may be stored on a server (which is described in more detail in connection with FIG. 13). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 13). In addition, communications circuitry may include circuitry that enables peer-to-peer communication of user equipment, or communication of user equipment in locations remote from each other (described in more detail below).

Memory may be an electronic storage device provided as storage 1308 that is part of control circuitry 1304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1308 may be used to store various types of content described herein as well as media application data described above. Nonvolatile memory may also be used (e.g., to launch a boot-up routine and other instructions). Cloud-based storage, described in relation to FIG. 13, may be used to supplement storage 1308 or instead of storage 1308.

Control circuitry 1304 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 1304 may also include scaler circuitry for upconverting and downconverting content into the preferred output format of user equipment 1300. Control circuitry 1304 may also include digital-to-analog converter circuitry and analog-to-digital converter circuitry for converting between digital and analog signals. The tuning and encoding circuitry may be used by user equipment 1300, 1301 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1308 is provided as a separate device from user equipment 1300, the tuning and encoding circuitry (including multiple tuners) may be associated with storage 1308.

Control circuitry 1304 may receive instruction from a user by way of user input interface 1310. User input interface 1310 may be any suitable user interface, such as a remote control, mouse, trackball, keypad, keyboard, touch screen, touchpad, stylus input, joystick, voice recognition interface, or other user input interfaces. Display 1312 may be provided as a stand-alone device or integrated with other elements of each one of user equipment 1300 and user equipment 1301. For example, display 1312 may be a touchscreen or touch-sensitive display. In such circumstances, user input interface 1310 may be integrated with or combined with display 1312. In some embodiments, user input interface 1310 includes a remote-control device having one or more microphones, buttons, keypads, any other components configured to receive user input or combinations thereof. For example, user input interface 1310 may include a handheld remote-control device having an alphanumeric keypad and option buttons. In a further example, user input interface 1310 may include a handheld remote-control device having a microphone and control circuitry configured to receive and identify voice commands and transmit information to set-top box 1316.

Audio output equipment 1314 may be integrated with or combined with display 1312. Display 1312 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1312. Audio output equipment 1314 may be provided as integrated with other elements of each one of device 1300 and device 1301 or may be stand-alone units. An audio component of videos and other content displayed on display 1312 may be played through speakers (or headphones) of audio output equipment 1314. In some embodiments, audio may be distributed to a receiver (not shown), which processes and outputs the audio via speakers of audio output equipment 1314. In some embodiments, for example, control circuitry 1304 is configured to provide audio cues to a user, or other audio feedback to a user, using speakers of audio output equipment 1314. There may be a separate microphone 1317 or audio output equipment 1314 may include a microphone configured to receive audio input such as voice commands or speech. For example, a user may speak letters or words that are received by the microphone and converted to text by control circuitry 1304. In a further example, a user may voice commands that are received by a microphone and recognized by control circuitry 1304. Camera 1318 may be any suitable video camera integrated with the equipment or externally connected. Camera 1318 may be a digital camera comprising a charge-coupled device (CCD) and/or a complementary metal-oxide semiconductor (CMOS) image sensor. Camera 1318 may be an analog camera that converts to digital images via a video card.

The media application and/or system integration application may be implemented using any suitable architecture. For example, it may be a stand-alone application wholly implemented on each one of user equipment 1300 and user equipment 1301. In such an approach, instructions of the application may be stored locally (e.g., in storage 1308), and data for use by the application is downloaded on a periodic basis (e.g., from an out-of-band feed, from an internet resource, or using another suitable approach). Control circuitry 1304 may retrieve instructions of the application from storage 1308 and process the instructions to provide video conferencing functionality and generate any of the displays discussed herein. Based on the processed instructions, control circuitry 1304 may determine what action to perform when input is received from user input interface 1310. For example, movement of a cursor on a display up/down may be indicated by the processed instructions when user input interface 1310 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1304 may allow a user to provide user profile information or may automatically compile user profile information. For example, control circuitry 1304 may access and monitor network data, video data, audio data, processing data, participation data from a conference participant profile. Control circuitry 1304 may obtain all or part of other user profiles that are related to a particular user (e.g., via social media networks), and/or obtain information about the user from other sources that control circuitry 1304 may access. As a result, a user can be provided with a unified experience across the user's different devices.

In some embodiments, the media application and/or system integration application is a client/server-based application. Data for use by a thick or thin client implemented on each one of user equipment 1300 and user equipment 1301 may be retrieved on-demand by issuing requests to a server remote to each one of user equipment 1300 and user equipment 1301. For example, the remote server may store the instructions for the application in a storage device. The remote server may process the stored instructions using circuitry (e.g., control circuitry 1304) and generate the displays discussed above and below. The client device may receive the displays generated by the remote server and may display the content of the displays locally on device 1300. This way, the processing of the instructions is performed remotely by the server while the resulting displays (e.g., that may include text, a keyboard, or other visuals) are provided locally on device 1300. Device 1300 may receive inputs from the user via input interface 1310 and transmit those inputs to the remote server for processing and generating the corresponding displays. For example, device 1300 may transmit a communication to the remote server indicating that an up/down button was selected via input interface 1310. The remote server may process instructions in accordance with that input and generate a display of the application corresponding to the input (e.g., a display that moves a cursor up/down). The generated display is then transmitted to device 1300 for presentation to the user.

In some embodiments, the media application and/or system integration application may be downloaded and interpreted or otherwise run by an interpreter or virtual machine (run by control circuitry 1304). In some embodiments, the media application may be encoded in the ETV Binary Interchange Format (EBIF), received by control circuitry 1304 as part of a suitable feed, and interpreted by a user agent running on control circuitry 1304. For example, the media application may be an EBIF application. In some embodiments, the media application may be defined by a series of JAVA-based files that are received and run by a local virtual machine or other suitable middleware executed by control circuitry 1304. In some of such embodiments (e.g., those employing MPEG-2, MPEG-4, HEVC or any other suitable digital media encoding schemes), the media application may be, for example, encoded and transmitted in an MPEG-2 object carousel with the MPEG audio and video packets of a program.

As shown in FIG. 13, user equipment 1406, 1407, 1408, 1410 (which may correspond to, e.g., e.g., system integration application 100 and 200 of FIGS. 1-2 may be coupled to communication network 1409. Communication network 1409 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1409) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 13 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 1402-11x, etc.), or other short-range communication via wired or wireless paths. The user equipment may also communicate with each other directly through an indirect path via communication network 1409.

System 1400 may comprise media content source 1402, one or more servers 1404, and/or one or more edge computing devices. In some embodiments, the media application or system integration application may be executed at one or more of control circuitry 1411 of server 1404 (and/or control circuitry of user equipment 1406, 1407, 1408, 1410 and/or control circuitry of one or more edge computing devices). In some embodiments, the media content source and/or server 1404 may be configured to host or otherwise facilitate video communication sessions between user equipment 1406, 1407, 1408, 1410 and/or any other suitable user equipment, and/or host or otherwise be in communication (e.g., over network 1409) with one or more social network services.

In some embodiments, server 1404 may include control circuitry 1411 and storage 1414 (e.g., RAM, ROM, Hard Disk, Removable Disk, etc.). Storage 1414 may store one or more databases. Server 1404 may also include an I/O path 1412. I/O path 412 may provide video conferencing data, device information, or other data, over a local area network (LAN) or wide area network (WAN), and/or other content and data to control circuitry 1411, which may include processing circuitry, and storage 1414. Control circuitry 1411 may be used to send and receive commands, requests, and other suitable data using I/O path 1412, which may comprise I/O circuitry. I/O path 1412 may connect control circuitry 1411 (and specifically control circuitry) to one or more communications paths.

Control circuitry 1411 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1411 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 1411 executes instructions for an emulation system application stored in memory (e.g., the storage 1414). Memory may be an electronic storage device provided as storage 1414 that is part of control circuitry 1411.

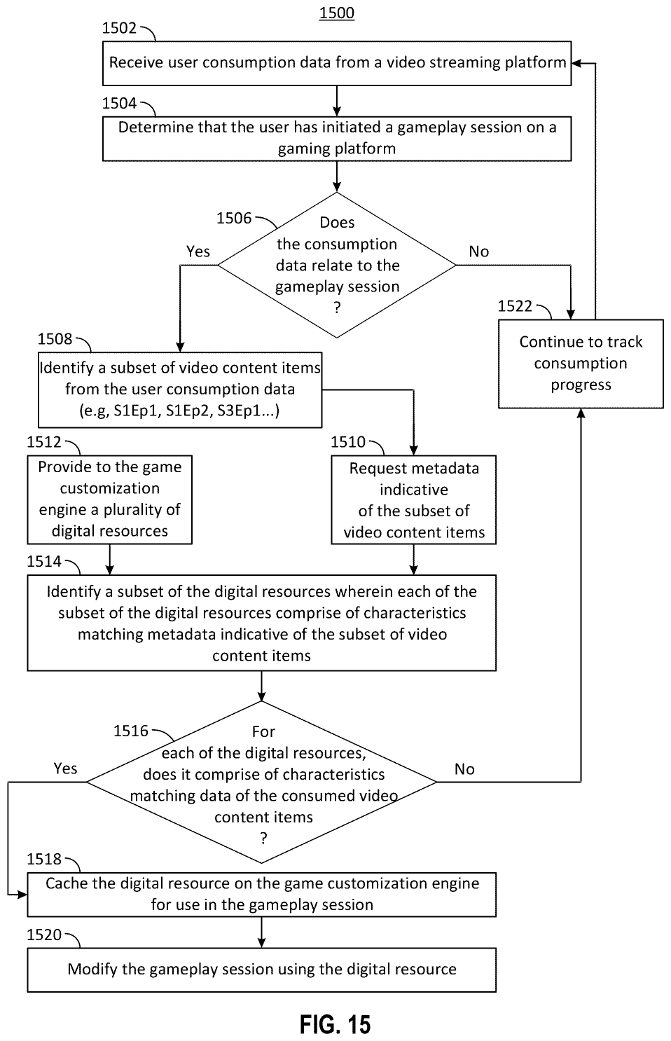

FIG. 15 shows a flowchart of system 1500 describing the customization of game content, in accordance with some embodiments of this disclosure.

At 1502, system 1500 receives user consumption data from a media streaming platform.

At 1504, system 1500 determines that the user has initiated a gameplay session on the gaming platform.

At 1506, system 1500 identifies a set of media content from the consumption data received from the media streaming platform. The system compares metadata for the media content to metadata for the gameplay session.

At 1508, system 1500 identifies a subset of video content items from the user consumption data. For example, the system determines that the consumption data includes media content “The Witcher Season 1” that is related to “The Witcher,” which is also the subject of the video game “The Witcher Video Game.”

At 1510, system 1500 requests metadata indicative of the subset of video content items. For example, the system sends a request to the media streaming platform for metadata of the episodes for “The Witcher Season 1.”

At 1512, the game customization engine receives a plurality of digital resources. For example, the game customization engine extracts a set of media elements from a resource database that may be implemented into the video game.

At 1514, system 1500 identifies a subset of the digital resources wherein each of the subsets of the digital resources comprise of characteristics matching metadata indicative of the subset of video content items. For example, the system selects from the media elements a subset of media elements that are related to the episodes for “The Witcher Season 1.”

At 1516, system 1500 determines whether the subset of the digital resources matches metadata of the consumed video content items. For example, the system determines whether the selected media elements are related to watched episodes for “The Witcher Season 1.”

At 1518, system 1500 determines that a digital resource matches a consumed video content item and caches the digital resource on the game customization engine for use in the gameplay session.

At 1520, the game customization engine modifies the game using the cached digital resource.

At 1522, system 1500 determines that the metadata for the media content does not relate to the metadata for the gameplay session. System 1500 continues to track consumption progress.

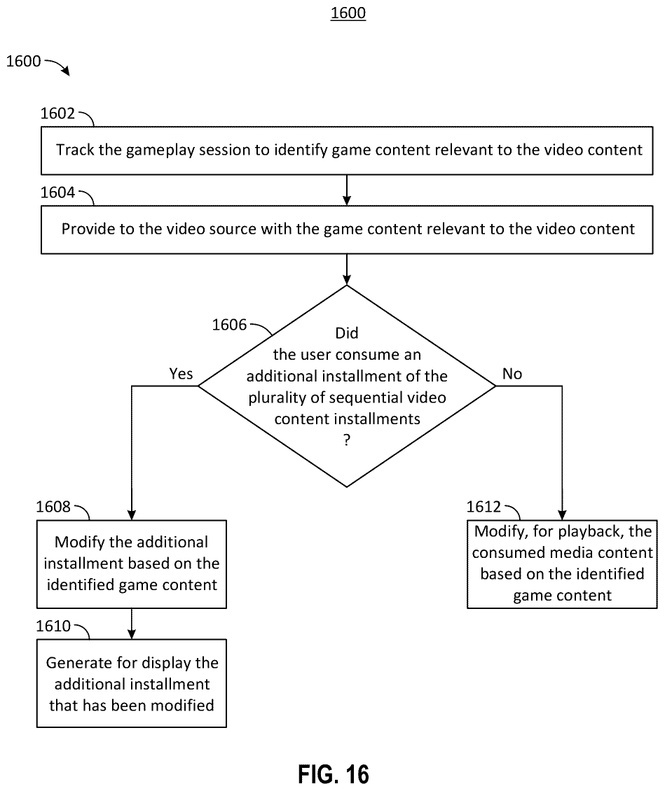

FIG. 16 shows a flowchart of system 1600 describing the bi-directional integration of media content, in accordance with some embodiments of this disclosure.

At 1602, system 1600 tracks a gameplay session to identify game content relevant to a video content.

At 1604, system 1600 provides to the video source with the game content relevant to the video content.

At 1606, system 1600 determines whether the user consumes an additional content item of the plurality of sequential video content items.

At 1608, system 1600 determines that the user consumed an additional content item and modifies the additional content item based on the identified game content.

At 1610, system 1600 generates for display the additional video content item that has been modified.

At 1612, system 1600 determines that the user did not consume an additional content item and modifies, for playback, the consumed media content based on the identified game content.

1. A method comprising:
tracking consumption progress, associated with a user profile, of a video content from a video service, wherein the video content comprises a plurality of sequential video content items of a series;
providing to a game customization engine:
(a) data indicative of the consumption progress, associated with the user profile, of the video content, and
(b) a plurality of digital resources associated with a subset of the sequential video content items indicated as consumed by the data indicative of the consumption progress; and
based at least in part on identifying a gameplay session of a game application associated with the user profile and associated with the series, modifying, by the game customization engine, the gameplay session using at least one of the digital resources associated with the subset of the sequential video content items indicated as consumed by the consumption progress.

2. The method of claim 1, further comprising:
tracking the gameplay session to identify game content relevant to the video content;
providing the identified game content relevant to the video content to the video source;
based at least in part on detecting consumption of an additional video content item of the plurality of sequential video content items by a device associated with the user profile:
generating for display the additional video content item that has been modified based on the identified game content.

3. The method of claim 1, wherein the modifying the gameplay session comprises:
identifying in a game timeline of the game application a gameplay element relevant to metadata of at least one of the subsets of the sequential video content items indicated as consumed by the consumption progress; and
modifying the gameplay element based on the at least one of the digital resources of the plurality of digital resources.

4. The method of claim 1, wherein the plurality of digital resources comprises at least one of: a game level data, a character model, a character outfit model, a digital location data, a text message, a video message, or an audio message.

5. The method of claim 1, wherein the modifying the gameplay session using the at least one of the digital resources associated with the subset of the sequential video content items further comprises:
retrieving data indicative of a character model from the plurality of digital resources;
identifying a matching character of the game application; and
replacing, in the gameplay session, data indicative of the matching character with data indicative of the character model from the plurality of digital resources.

6. The method of claim 1, wherein the modifying the gameplay session using the at least one of the digital resources associated with the subset of the sequential video content items further comprises:
determining a semantic analysis of text message data from the plurality of digital resources using a large language model;
identifying an element from the semantic analysis of text message data.

7. The method of claim 1, wherein the modifying the gameplay session comprises:
identifying a plurality of unlockable items in the game application wherein the unlockable items are features relating to a particular video content item of the plurality of sequential video content items;
determining that the user profile has consumed the particular video content item; and
unlocking the item for the user profile to access within the game application.

8. The method of claim 1, wherein the video content comprises a plurality of paths for consuming the plurality of sequential video content items, wherein the paths are selectable by a user interface; and
wherein the gameplay session is modified based on a selected path of plurality of paths for consuming the plurality of sequential video content items.

9. The method of claim 1, further comprising:
receiving user preferences, associated with the user profile, identifying preferred media elements associated with the video content;
wherein the providing to the game customization engine the plurality of digital resources comprises providing the identified preferred media elements; and
wherein the modifying the gameplay session comprises:
modifying the gameplay session using the identified preferred media elements.

10. The method of claim 1, wherein the tracking the consumption progress comprises:
monitoring, using a media analysis module, a media viewing history of the user profile, wherein the media viewing history comprises media elements of at least one of plot points of the video content, characters of the video content, settings of the video content, episodes of the video content, or watch time of the video content.

11. The method of claim 1, further comprising:
identifying a plurality of user profiles associated with a group watch consumption session of the video content from the video source;
identifying a multiplayer gameplay session of the game application associated with a subset of the plurality of user profiles; and
based at least in part on identifying the multiplayer gameplay session of the game application associated with the subset of the plurality of user profiles, modifying, by the game customization engine, the multiplayer gameplay session using at least one of resources associated with the subset of the sequential video content items indicated as consumed by consumption progress of the group watching consumption session.

12. The method of claim 11, wherein the modifying the multiplayer gameplay session comprises:
receiving, from the plurality of user profiles, a plurality of selections of the subset of the sequential video content items; and
modifying the multiplayer gameplay session based on the plurality of selections.

13. The method of claim 11, further comprising:
tracking the multiplayer gameplay session to identify additional game content relevant to the video content;
providing the video source with the identified additional game content relevant to the video content;
based at least in part on detecting consumption of an additional video content item of the plurality of sequential video content items by a plurality of devices associated with the plurality of user profiles:
generating for display in a group watch session the additional video content item that has been modified based on the identified additional game content.

14. The method of claim 11, wherein the modifying the multiplayer gameplay session comprises:
accessing conversation data from the plurality of user profiles consuming the video content from the video source;
identifying, from the conversation data, a group preference for a digital resource of the plurality of digital resources associated with the subset of the sequential video content items indicated as consumed by the consumption progress; and
modifying the multiplayer gameplay session using the group preference for the digital resource of the plurality of digital resources.

15. The method of claim 11, wherein the modifying the multiplayer gameplay session comprises:
retrieving conversation data from the plurality of user profiles consuming the video content from the video source;
identifying, from the conversation data, a preference for a change in a storyline of the video content; and
modifying the multiplayer gameplay session based on the preference for the change in the storyline of the video content.

16. The method of claim 2, wherein the generating for display the additional video content items that have been modified further comprises:
identifying a static portion of at least one frame of the additional video content item;
modifying the static portion of the at least one frame of the additional video content item to include digital resources from the identified game content; and
generating for display the additional video content item with the modified static portion of at least one frame.

17. The method of claim 2, wherein the generating for display the additional video content item that have been modified further comprises:
determining, from metadata of the additional video content item, that an object displayed in the additional video content item can be modified;
identifying a portion of at least one frame of the additional video content item that includes a representation of the object;
modifying the representation of the object in the at least one frame of the additional video content item to display digital resources from the identified game content; and
generating for display the additional video content item with the modified portion of at least one frame including the digital resources.

18. The method of claim 1, wherein the gameplay session is modified based on the at least one digital resources associated with the subset of the sequential video content items indicated as consumed by the consumption progress that were provided to the game customization engine prior to the gameplay session being launched.

19. A system comprising:
control circuitry configured to:
track consumption progress, associated with a user profile, of a video content from a video service, wherein the video content comprises a plurality of sequential video content items of a series;
provide to a game customization engine:
(a) data indicative of the consumption progress, associated with the user profile, of the video content, and
(b) a plurality of digital resources associated with a subset of the sequential video content items indicated as consumed by the data indicative of the consumption progress; and
based at least in part on identifying a gameplay session of a game application associated with the user profile and associated with the series, modifying, by the game customization engine, the gameplay session using at least one of the digital resources associated with the subset of the sequential video content items indicated as consumed by the consumption progress.

20. The system of claim 19, wherein the circuitry is further configured to:
track the gameplay session to identify game content relevant to the video content;
provide the identified game content relevant to the video content to the video source;
based at least in part on detecting consumption of an additional video content item of the plurality of sequential video content items by a device associated with the user profile:
generate for display the additional video content item that has been modified based on the identified game content.
